(19) United States
(12) Patent Application Publication
(10) Pub. No.: US 2025/0320435 A1
(43) Pub. Date: Oct. 16, 2025

(54) CLEANING AGENT COMPOSITION AND CLEANING METHOD

(71) Applicant: SHIKOKU CHEMICALS CORPORATION, Kagawa (JP)

(72) Inventors: Koichi SAHIRO, Tokushima (JP); Mikio IWATA, Tokushima (JP); Akihiro NORIMOTO, Tokushima (JP)

(73) Assignee: SHIKOKU CHEMICALS CORPORATION, Kagawa (JP)

(21) Appl. No.: 18/861,109

(22) PCT Filed: May 10, 2023
(86) PCT No.: PCT/JP2023/017523

§ 371 Date: Oct. 28, 2024

(30) Foreign Application Priority Data
May 13, 2022 (JP) 2022-079183

(51) Int. Cl. C11D 3/395; C11D 3/00; C11D 3/08

(52) U.S. Cl. CPC C11D 3/3953; C11D 3/0047; C11D 3/08

(57) ABSTRACT

The present invention provides a solid cleaning composition that contains solid chlorine bleach and an alkaline compound in high concentrations in order to remove strongly adhered mold, biofilm, and other dirt, the solid cleaning composition inhibiting heat generation that would occur when the cleaning composition is brought into contact with a small amount of water, and being capable of preventing breakage of a container containing the cleaning composition due to swelling of the container or the like, and having improved storage stability. The present invention further provides a method for using the solid cleaning composition. The present invention is directed to a solid cleaning composition containing: a material containing solid chlorine bleach having a coating layer; and an alkaline compound. The cleaning composition has an effective chlorine content of 5% or more and a water content of 40 wt. % or less. A 1 wt. % aqueous solution of the cleaning composition has a pH of 9 or more. The present invention is further directed to a cleaning method using the cleaning composition.

### TECHNICAL FIELD

The present invention relates a cleaning composition suitable for use in cleaning equipment and hard surfaces in the vicinity of water, such as kitchens, washrooms, toilets, the inside of drainpipes, and washing machine drums, and a method for using the cleaning composition.

### BACKGROUND ART

Various cleaning compositions are in use to clean equipment and hard surfaces in the vicinity of water, such as kitchens, washrooms, toilets, the inside of drainpipes, and washing machine drums. These vessels and hard surfaces are made of various materials, such as ceramics, pottery, tiles, resins, and metals. Such cleaning compositions contain cleaning components, such as bleaching agents and alkaline compounds, which can remove or disguise dirt on the object to be cleaned.

Cleaning compositions containing a bleaching agent may cause defects, such as metal-surface rusting due to influence of the bleaching agent. To prevent such defects, a method for reducing corrosiveness to metals by further incorporating a compound having an anti-corrosion effect into a bleaching-agent-containing cleaning composition may be used. For example, Patent Literature (PTL) 1 discloses a cleanser composition for washing machine drums, comprising a dichloroisocyanurate and sodium metasilicate pentahydrate with only the particle surfaces subjected to a low hydration treatment. PTL1 describes that this composition can effectively peel or remove film dirt composed of, for example, fungi, bacteria, and detergent, or other contaminants, adhered to the back side of a washing machine drum, also exhibits low corrosiveness to various metals when dissolved in water and used, and scarcely produces pungent odors. Furthermore, even when this composition is stored under relatively high-temperature conditions, caking (solidification) can be inhibited (excellent storage stability).

Further, alkaline compounds, such as sodium metasilicate, upon contact with a bleach, may cause problems, such as degrading the bleaching agent and reducing bleaching effects. To solve such problems, for example, Patent Literature (PTL) 2 reports a solid-bleaching-agent-containing material wherein particles of the bleaching agent are protected by a coating layer. PLT 2 discloses that in a cleaning composition comprising this solid-bleaching-agent-containing material and an alkali compound, the bleaching agent is protected from deterioration, deactivation, and decomposition.

### CITATION LIST

### Patent Literature

PTL 1: JP2007-217569A
PTL 2: WO2017/183726

### SUMMARY OF INVENTION

### Technical Problem

When mold, biofilm, and other dirt strongly adhere to areas where direct cleaning by scrubbing etc. are impossible or areas that are difficult to clean on a daily basis, it is generally difficult to effectively remove such dirt. The present inventors attempted to prepare a solid cleaning composition comprising a solid chlorine bleaching agent and an alkaline compound in higher concentrations than ever in order to remove such strongly adhered dirt.

However, such a solid cleaning composition containing high concentrations of a solid chlorine bleaching agent and an alkaline compound generates significantly high heat when brought into contact with water at the time of use. Such heat generation could lead to problems, such as reduced safety during use and corrosion or degradation of the material surface to be cleaned. Furthermore, the presence of water in the cleaning composition may cause active ingredients to decompose during storage, which may result in poor cleaning performance or cause a container containing the cleaning composition to swell and break, thus incurring problems such as insufficient storage stability of the cleaning composition. In cleaning compositions containing active ingredients at high concentrations, improvement in these problems was strongly desired.

Accordingly, an object of the present invention is to provide a solid cleaning composition containing solid chlorine bleach and an alkaline compound in high concentrations to remove strongly adhered mold, biofilm, and other dirt, the composition inhibiting heat generation when brought into contact with a small amount of water and having improved storage stability such that breakage due to, for example, swelling of a container containing the cleaning composition can be prevented during storage. Another object of the present invention is to provide a method for using the cleaning composition.

### Solution to Problem

The present inventors conducted extensive research to solve the above problem. As a result, the inventors found that when a solid cleaning composition comprises a material containing solid chlorine bleach having a coating layer and an alkaline compound such as metasilicate and has an effective chlorine content of 5% or more and a water content of 40 wt. % or less and the cleaning composition in the form of a 1 wt. % aqueous solution has a pH of 9 or more, the cleaning composition can exhibit a high cleaning effect against stubborn dirt, high-temperature heat generation can be effectively inhibited when the cleaning composition in the form of a high-concentration aqueous solution comes into contact with a small amount of water during use, and degradation due to decomposition of active ingredients during storage and breakage due to swelling of the packaging container caused thereby can be inhibited, thus being capable of stably maintaining a breach composition over a long period of time.

The present inventors further found that in order to enhance cleaning effects, the cleaning composition of the present invention can further contain other components, such as a metal ion scavenger, a surfactant, a polymer dispersant, an organic acid, a polysaccharide, a thickener, and a fluorescent whitener as additives that are effective for various types of cleaning; and that even in such a case, the resulting cleaning composition can achieve the above effects.

As a result of further research and consideration based on these findings, the present invention has been accomplished.

The present invention provides the following cleaning compositions and cleaning methods using the cleaning compositions.

### Item 1.

A solid cleaning composition comprising a material containing solid chlorine bleach having a coating layer, and an alkaline compound,
wherein the cleaning composition has an effective chlorine content of 5% or more and a water content of 40 wt. % or less, and a 1 wt. % aqueous solution of the cleaning composition has a pH of 9 or higher.

### Item 2.

The cleaning composition according to Item 1, wherein the content of the alkaline compound (excluding bound water when the alkaline compound contains bound water) in the cleaning composition is 5 wt. % or more.

### Item 3.

The cleaning composition according to Item 1 or 2, wherein the sum of the effective chlorine content and the content of the alkaline compound (excluding bound water when the alkaline compound contains bound water) in the cleaning composition is 40 or more.

### Item 4.

The cleaning composition according to any one of Items 1 to 3, wherein the ratio of the effective chlorine content to the alkaline compound content (effective chlorine content/alkaline compound content) in the cleaning composition is in the range of 0.1 to 0.8.

### Item 5.

The cleaning composition according to any one of Items 1 to 4, wherein the alkaline compound is at least one member selected from the group consisting of metal metasilicates, metal metasilicate hydrates, metal phosphates, and metal phosphate hydrates.

### Item 6.

The cleaning composition according to any one of Items 1 to 5, wherein the water derived from the alkaline compound accounts for 60 wt. % or more of the water content of the cleaning composition.

### Item 7.

The cleaning composition according to any one of Items 1 to 6, wherein the water content of the cleaning composition is 32 wt. % or less.

### Item 8.

The cleaning composition according to any one of claims 1 to 7, wherein a 1 wt. % aqueous solution of the cleaning composition has a pH of 10.5 or higher.

### Item 9.

A method for cleaning an object, comprising bringing an aqueous solution of the cleaning composition of any one of Items 1 to 8 into contact with the object.

### Advantageous Effects of Invention

The cleaning composition of the present invention contains a material containing solid chlorine bleach having a coating layer as a bleaching agent, and an alkaline compound, such as metasilicate, at high concentrations, and has a water content within a predetermined range. Based on these features, the cleaning composition of the present invention has high cleaning (bleaching) effects, heat generation that would occur when the cleaning composition is dissolved in water is inhibited, and the cleaning composition inhibits swelling and breakage of a packaging container containing the cleaning composition; furthermore, the chlorine bleach in the cleaning composition is stably maintained.

In the present specification, “inhibit heat generation” means that the highest temperature achieved by temperature rise due to heat generation of the cleaning composition when water is added to a predetermined amount of the cleaning composition is lower than that of a comparative composition. “Inhibit swelling and breakage of the packaging container” means that when the cleaning composition is sealed in a predetermined packaging container, the increase in volume of the packaging container is smaller than that of the same container containing a comparative composition, or the time it takes until the packaging container partially swells and breaks is longer than that of a comparative composition, or the degree of breakage of the packaging container is smaller than that of the comparative composition. “Stably maintain the chlorine bleach” means that when the cleaning composition is stored under predetermined conditions for a certain period of time, the reduction in effective chlorine content of the chlorine bleach as an active ingredient is smaller than that of the comparative composition.

### DESCRIPTION OF EMBODIMENTS

### Cleaning Composition

The cleaning composition of the present invention is suitable for use in cleaning equipment and hard surfaces in the vicinity of water, such as kitchens, washrooms, toilets, the inside of drainpipes, and washing machine drums. This cleaning composition has a high bleaching effect and thus can be used for a wide range of applications. Examples of equipment and hard surfaces in the vicinity of water include water faucets or handles; strainers; sinks; triangular corners; chopping boards; tableware; dishwashers; stove tops; trivets; ventilation fans, including sirocco fans (including covers or hood portions); the inside of drainpipes; microwave ovens; refrigerators; washroom sinks or their surroundings; water-filled portions of toilet bowls or the inside of tanks; bath tubs; drain covers or strainers; ceilings, walls, floors, doors, rubber seals, or tile joints in the vicinity of water in, for example, bathrooms, kitchens, toilets, and washrooms; washing machine drums, drainage ports, lint filters, and the like. Other examples of applications include dentures (including partial dentures).

When the target to be cleaned is an object where water is accumulated beforehand, such as water-filled portions of toilet bowls or drainage ports, the cleaning method using the cleaning composition of the present invention can be directly throwing the cleaning composition into water. When the object to be cleaned is configured to freely hold water, such as a sink, a bathtub, or a washing machine, the cleaning composition may be added after filling with water, or water may be added after the cleaning composition has been placed inside. Specifically, the cleaning method of the present invention comprises the steps of: dissolving the cleaning composition in water to prepare an aqueous solution; and bringing the target object into contact with the aqueous solution that is prepared by dissolving the cleaning composition in water.

When a washing machine drum is to be cleaned, the cleaning composition of the present invention is applicable to both drum-type and vertical washing machines. Water may be poured into the washing machine drum after the cleaning composition is placed into the washing machine drum, or the cleaning composition may be added after the washing machine drum has been filled with water. The washing machine drum may be cleaned by using a washing drum cleaning course or the like provided in the washing machine, or the washing machine drum may be cleaned by using a normal washing course. When a washing machine drum is cleaned, the aqueous cleaning solution in the washing machine drum flows through a lint filter provided in the washing machine and a drainage port after the washing drum cleaning course has finished, whereby cleaning of the lint filter and the drainage port can follow the cleaning of the washing machine drum. Alternatively, the lint filter and drain can also be cleaned directly with the cleaning composition.

When detachable utensils, such as triangular corners, chopping boards, tableware, stove tops, trivets, ventilation fans, and dentures, are to be cleaned, cleaning may be performed by placing the cleaning composition into a container filled with water beforehand to dissolve the composition, and immersing the target utensils to be cleaned in the aqueous solution; or by pouring the aqueous solution over the object to be cleaned. Alternatively, a wide range of commonly known cleaning methods, such as wiping off with a cloth that has been soaked with an aqueous solution of the cleaning composition, can be used.

### Material Containing Solid Chlorine Bleach Having a Coating Layer

In the material containing a solid chlorine bleach having a coating layer for use in the present invention, particles of the chlorine bleach are protected with a coating layer. The compound used to form the coating layer is not particularly limited as long as it can coat the solid chlorine bleach to inhibit the interaction between the solid chlorine bleach and other cleaning components.

Examples of compounds that can be used to form the coating layer include metal salts of carboxylic acids, surfactants, polysaccharides, higher fatty acids, paraffin waxes, zeolites, and resins. These compounds can be used alone or in a combination of two or more. Examples of embodiments in which two or more compounds are used in combination include an embodiment in which two or more compounds are mixed to form a coating layer containing multiple compounds; and an embodiment in which a coating layer is formed by using one compound and then another coating layer is formed thereon by using another compound to make a multi-layer structure. The coating layer may be formed to completely cover the solid chlorine bleach or may be partially formed as long as the effect of the present invention is not impaired. Among the compounds that can be used as the coating layer, metal salts of carboxylic acids and surfactants are preferred in view of their good solubility in water and excellent stability with the solid chlorine bleach. Metal salts of carboxylic acids are more preferred because such salts are easy to process into a coating layer, have an excellent function as a coating layer in protecting the solid chlorine bleach, are easily available, and are easy to handle.

Examples of metal salts of carboxylic acids include at least one member selected from the group consisting of metal salts of aromatic carboxylic acids, metal salts of acyclic dicarboxylic acids, metal salts of acyclic monocarboxylic acids, metal salts of other carboxylic acids, and mixtures thereof. Metal salts of carboxylic acids may be, for example, one in which carboxyl groups of the carboxylic acid are completely neutralized into metal salts, one in which carboxyl groups of the carboxylic acid are partially neutralized into metal salts, or one including carboxylic acids that have yet to be formed into metal salts. Based on using a metal salt of a carboxylic acid, a material containing solid chlorine bleach having a coating layer or a cleaning composition containing the material containing solid chlorine bleach having a coating layer can protect the solid chlorine bleach from degradation, deactivation, and decomposition to thereby achieve stability.

Furthermore, the coating layer formed by incorporating a metal salt of carboxylic acid is stable even when in contact with the solid chlorine bleach, and no adverse side reactions occur between the solid chlorine bleach and the coating layer. Therefore, a coating layer can be directly provided on the surface of the solid chlorine bleach without the necessity of providing another layer for separating the solid chlorine bleach from the coating layer. In addition, the coating layer containing a metal salt of a carboxylic acid is preferred because it is less likely to aggregate and has excellent processability.

Metal salts of aromatic carboxylic acids refer to metal salts of compounds that have an aromatic ring in the structure of the compound and that have a carboxyl group. Preferable examples of metal salts of aromatic carboxylic acids are at least one member selected from the group consisting of metal salts of benzoic acid, phthalic acid (ortho-phthalic acid), isophthalic acid (meta-phthalic acid), terephthalic acid (para-phthalic acid), trimellitic acid, and para-t-butylbenzoic acid, and mixtures thereof. Examples of metal salts include alkali metal salts such as lithium salts, sodium salts, and potassium salts, and alkaline earth metal salts such as calcium salts and magnesium salts. In view of ease of availability, alkali metal salts are preferred. In view of solubility in water, sodium salts and potassium salts are more preferred. Particularly preferable examples of metal salts of aromatic carboxylic acids are at least one member selected from the group consisting of alkali metal salts of benzoic acid, alkali metal salts of para-t-butylbenzoic acid, and mixtures thereof. A preferable example of alkali metal salts of benzoic acid is sodium benzoate. A preferable example of alkali metal salts of para-t-butylbenzoic acid is sodium para-t-butylbenzoate.

Metal salts of acyclic dicarboxylic acids refer to metal salts of compounds that do not have a cyclic structure in the structure of the compound and that have two carboxyl groups. Examples of metal salts of acyclic dicarboxylic acids are at least one member selected from the group consisting of metal, salts of oxalic acid, malonic acid, succinic acid, fumaric acid, maleic acid, D-tartaric acid, L-tartaric acid, D-malic acid, L-malic acid, D-aspartic acid, L-aspartic acid, glutaric acid, D-glutamic acid, L-glutamic acid, itaconic acid, adipic acid, pimelic acid, suberic acid, azelaic acid, sebacic acid, undecanedioic acid, dodecanedioic acid, and tetradecanedioic acid, and mixtures of these metal salts. Examples of metal salts include alkali metal salts such as lithium salts, sodium salts, and potassium salts, and alkaline earth metal salts such as calcium salts and magnesium salts. In view of ease of availability, alkali metal salts are preferred. In view of solubility in water, sodium salts and potassium salts are more preferred. Preferable examples of metal salts of acyclic dicarboxylic acids are at least one member selected from the group consisting of alkali metal salts of adipic acid, alkali metal salts of sebacic acid, alkali metal salts of undecanedioic acid, alkali metal salts of dodecanedioic acid, and mixtures thereof. A preferable example of alkali metal salts of adipic acid is disodium adipate. A preferable example of alkali metal salts of sebacic acid is disodium sebacate. A preferable example of alkali metal salts of undecanedioic acid is disodium undecanedioate. A preferable example of alkali metal salts of decanedioic acid is disodium dodecanedioate.

“Metal salts of acyclic monocarboxylic acids” refer to metal salts of compounds that have no cyclic structure in the structure of the compound and that have one carboxyl group. Examples of metal salts of acyclic monocarboxylic acids include at least one member selected from the group consisting of metal salts of formic acid, acetic acid, propionic acid, butyric acid, valeric acid, hexanoic acid (caproic acid), heptanoic acid (enanthic acid), octanoic acid, nonanoic acid, decanoic acid, dodecanoic acid, lauric acid, myristic acid, palmitic acid, stearic acid, arachidic acid, behenic acid, oleic acid, linoleic 2.0 acid, linolenic acid, acrylic acid, methacrylic acid, isobutyric acid, and isovaleric acid; and mixtures thereof. Examples of metal salts include alkali metal salts such as lithium salts, sodium salts, and potassium salts, and alkaline earth metal salts such as calcium salts and magnesium salts. In view of ease of availability, alkali metal salts are preferred. In view of solubility in water, sodium salts and potassium salts are more preferred. Preferable examples of metal salts of acyclic monocarboxylic acids are at least one member selected from the group consisting of alkali metal salts of heptanoic acid (enanthic acid), alkali metal salts of octanoic acid, alkali metal salts of nonanoic acid, alkali metal salts of decanoic acid, alkali metal salts of dodecanoic acid, alkali metal salts of lauric acid, alkali metal salts of myristic acid, alkali metal salts of palmitic acid, alkali metal salts of stearic acid, and mixtures thereof. A preferable example of alkali metal salts of heptanoic acid (enanthic acid) is sodium heptanoate. A preferable example of alkali metal salts of octanoic acid is sodium octanoate. A preferable example of alkali metal salts of nonanoic acid is sodium nonanoate. A preferable example of alkali metal salts of decanoic acid is sodium decanoate. A preferable example of alkali metal salts of dodecanoic acid is sodium dodecanoate. A preferable example of alkali metal salts of lauric acid is sodium laurate. A preferable example of alkali metal salts of myristic acid is sodium myristate. A preferable example of alkali metal salts of palmitic acid is sodium palmitate. A preferable example of alkali metal salts of stearic acid is sodium stearate.

Metal salts of other carboxylic acids refer to metal salts of compounds that may have a cyclic structure in the structure of the compound and that have three or more carboxyl groups. Preferable examples of metal salts of other carboxylic acids are metal salts of citric acid. Examples of metal salts include alkali metal salts such as lithium salts, sodium salts, and potassium salts, and alkaline earth metal salts such as calcium salts. In view of ease of availability, alkali metal salts are preferred. In view of solubility in water, sodium salts and potassium salts are more preferred. A preferable example of alkali metal salts of citric acid is trisodium citrate.

Metal salts of aromatic carboxylic acids, metal salts of acyclic dicarboxylic acids, metal salts of acyclic monocarboxylic acids, and metal salts of other carboxylic acids may be used alone or in a combination of two or more of such compounds.

In the material containing solid chlorine bleach having a coating layer, the content of the metal salt of carboxylic acid in the coating layer is preferably 30 wt. % or more, more preferably 50 wt. % or more, and even more preferably 70 wt. % or more, based on the total weight of the coating layer taken as 100 wt. %, in view of ease of forming a coating layer on the solid chlorine bleach.

Examples of surfactants that can be used to form the coating layer include various anionic surfactants, non-ionic surfactants, cationic surfactants, and amphoteric surfactants. In view of ease of availability and excellent stability with the solid chlorine bleach, anionic surfactants are preferred. Examples of anionic surfactants include sulfates such as alkyl sulfates (e.g., sodium lauryl sulfate) and polyoxyethylene alkyl sulfates; sulfonates such as linear alkylbenzene sulfonates, α-sulfo fatty acid methyl ester salts, α-olefin sulfonates (e.g., sodium α-olefin sulfonate), and dialkyl sulfosuccinates. Among these, sodium lauryl sulfate and sodium α-olefin sulfonate are preferred in view of good stability with the chlorine bleach and ease of handling as a coating layer.

In the material containing solid chlorine bleach having a coating layer, the surfactant content of the coating layer is preferably 5 wt. % or more, more preferably 20 wt. % or more, and even more preferably 50 wt. % or more, based on the total weight of the coating layer taken as 100 wt. %, in view of ease of forming a coating layer on the solid chlorine bleach. A combination of a metal salt of carboxylic acid and a surfactant can also be used to form a coating layer.

The coating layer may contain various compounds such as inorganic compounds and organic compounds as long as such compounds do not impair the effect of the present invention. Examples of inorganic compounds include, but are not limited to, phosphates, sulfates, silicates, chlorides, iodides, and bromides. Examples of organic compounds include, but are not limited to, polysaccharides, polymer compounds, and salts of organic compounds.

The proportion (wt. %) of the coating layer in the material containing solid chlorine bleach having a coating layer is preferably within the following range in view of obtaining a stabilizing effect on the solid chlorine bleach by the coating layer: the lower limit is preferably 5 wt. % or more, more preferably 10 wt. % or more, and even more preferably 15 wt. % or more, based on the total weight of the material containing solid chlorine bleach having a coating layer being taken as 100 wt. 8. In view of obtaining a sufficient stabilizing effect on the solid chlorine bleach without excessively increasing the proportion of the coating layer, the upper limit is preferably 70 wt. % or less, more preferably 50 wt. % or less, and even more preferably 45 wt. % or less.

In order to calculate the proportion of the coating layer in the material containing solid chlorine bleach having a coating layer, the calculation method according to the following Equation 1 can be used.

$$Proportion of coating layer ( wt . \% ) = Q 1 \times 100 / Q 2 \qquad ( Equation 1 )$$

Q1: Weight (g) of coating layer in the material containing solid chlorine bleach having a coating layer
Q2: Weight (g) of material containing solid chlorine bleach having a coating layer

For example, when 1 g of the material containing solid chlorine bleach having a coating layer contains 0.3 g of the coating layer, the proportion of the coating layer (wt. %) is calculated as 30 wt. % from 0.3×100/1=30 according to Equation 1. The weight of the coating layer in the material containing solid chlorine bleach having a coating layer may be determined, for example, by dissolving the material containing solid chlorine bleach having a coating layer in a solvent such as water and analyzing the solution by a known analytical method such as liquid chromatography to quantify the weight of the compound used in the coating layer, or by subtracting the weight of the solid chlorine bleach from the weight of the material containing solid chlorine bleach having a coating layer. The weight of the solid chlorine bleach may be determined by using a known analytical method, such as liquid chromatography.

The identification and quantification of the coating layer can be made by already known measurement methods. For example, if the absorbance of the compound used to form the coating layer is known, the proportion (wt. %) of the coating layer can be calculated by adjusting the compound used in the coating layer to a known concentration and creating a calibration curve (absorbance method), or measured by widely known methods, such as liquid chromatography or gas chromatography. When quantifying the solid chlorine bleach is easier than quantifying the coating layer, the weight of the coating layer can be calculated from the weight of the solid chlorine bleach.

The proportion of the coating layer can be calculated from the effective chlorine content of the material containing solid chlorine bleach according to the following Equation 2:

$$Proportion of the coating layer ( wt . \% ) = ( P 1 - P 2 ) \times 100 / P 1 \qquad ( Equation 2 )$$

P1: Effective chlorine content (%) of solid chlorine bleach used as a starting material

P2: Effective chlorine content (%) of material containing solid chlorine bleach having a coating layer

Specifically, for example, when a material containing solid chlorine bleach having a coating layer is produced by using sodium dichloroisocyanurate with an effective chlorine content of 64.5% as the solid chlorine bleach and if the effective chlorine content of the material containing solid chlorine bleach having a coating layer is 40.0%, the proportion of the coating layer is calculated as 38.0% according to Equation 2.

The contents of the surfactant and metal salt of carboxylic acid in the coating layer of the material containing solid chlorine bleach having a coating layer may be determined by using a known analytical method, such as liquid chromatography. For example, if the content of the surfactant or metal salt of carboxylic acid in the material containing solid chlorine bleach having a coating layer is 5 wt. % and if the coating layer accounts for 30 wt. % of the material containing solid chlorine bleach having a coating layer, the content of the surfactant or metal salt of carboxylic acid in the coating layer is calculated as 16.7 wt.&, based on the total weight of the coating layer taken as 100 wt. 8.

The method for quantifying the proportion of the coating layer in the material containing a solid chlorine bleach having a coating layer and the content of the compounds in the coating layer can be any of the methods described above, or any appropriate known methods. Even if there is an error in the results obtained by some measurement methods, as long as the numerical value obtained by any one of the measurement methods falls within the predetermined range, it can be regarded as satisfying the requirements even if the results obtained by other measurement methods fall outside the predetermined range.

The cleaning composition may further contain, in addition to the material containing solid chlorine bleach having a coating layer, another solid bleaching agent that has no coating layer (which may be simply referred to as a solid bleaching agent) as long as the effect of the invention is not impaired. When the cleaning composition contains this solid bleaching agent, the ratio of the content of the solid bleaching agent to the material containing solid chlorine bleach having a coating layer in the cleaning composition (content of solid bleaching agent/content of material containing solid chlorine bleach having a coating layer) is preferably 1 or less, more preferably 0.8 or less, and even more preferably 0.5 or less. Such a content ratio is preferable because a content ratio of 1 or less means that the content of the material containing solid chlorine bleach having a coating layer in the cleaning composition is equal to or higher than the content of the solid bleaching agent (having no coating layer), whereby heat generation by the material containing solid chlorine bleach having a coating layer can be inhibited to a low level, and the cleaning composition tends to easily obtain excellent storage stability effects and is also more economically advantageous than a cleaning composition composed entirely of a material containing solid chlorine bleach having a coating layer.

The cleaning composition, which contains solid chlorine bleach, has excellent cleaning, sterilization, and bleaching effects.

The cleaning composition may contain, in addition to the solid chlorine bleach, an oxygen bleaching agent as long as the effect of the present invention is not impaired. Examples of oxygen bleaching agents include sodium percarbonate, sodium perborate, organic peroxides such as benzoic acid peroxide, and double salts of mono-potassium persulfate. In view of ease of availability and handleability, sodium percarbonate and sodium perborate are preferred. Such oxygen bleaching agents can be used alone or in a combination of two or more.

Examples of solid chlorine bleaches include trichloroisocyanuric acid, sodium dichloroisocyanurate, sodium dichloroisocyanurate hydrate, potassium dichloroisocyanurate, dichlorohydantoin, chlorobromohydantoin, calcium hypochlorite, and crystallized sodium hypochlorite. In view of excellent bleaching effect and ease of handling and availability, trichloroisocyanuric acid, sodium dichloroisocyanurate, and sodium dichloroisocyanurate hydrate are more preferred. Such solid chlorine bleaches may be used alone or in a combination of two or more.

The effective chlorine content (in terms of Cl₂) of the solid chlorine bleach can be calculated by using the iodine titration method. That is, iodine liberated by the reaction of active chlorine and potassium iodide is titrated with an aqueous sodium thiosulfate solution, and the effective chlorine content is calculated according to the following Equation 3.

$$Effective chlorine content \% = a \times f \times 0.35452 / b \qquad ( Equation 3 )$$

a: 0.1N aqueous sodium thiosulfate solution (ml) required for titration

### b: Sample (g)

f: Factor of 0.1N aqueous sodium thiosulfate solution

The theoretical effective chlorine content of trichloroisocyanuric acid is 91.5%, that of sodium dichloroisocyanurate is 64.5%, and that of sodium dichloroisocyanurate dihydrate is 55.4%.

In view of incorporating compounds useful as a cleaning agent, such as an alkaline compound, water, and other additives, while the cleaning composition has an effective chlorine content at a certain level or higher, the content of the material containing solid chlorine bleach having a coating layer in the cleaning composition is preferably 5 to 80 wt. %, more preferably 10 to 70 wt. %, even more preferably 15 to 60 wt. %, still even more preferably 20 to 60 wt. %, and most preferably 30 to 60 wt. %, based on the total weight of the entire cleaning composition taken as 100 wt. %.

In view of obtaining good cleaning and bleaching effects, the effective chlorine content of the cleaning composition containing solid chlorine bleach must be 5% or more, is preferably 6% or more, more preferably 10% or more, even more preferably 13% or more, and still even more preferably 15% or more. In view of incorporating additives other than solid chlorine bleach while the cleaning composition has a sufficient effective chlorine content, the effective chlorine content of the cleaning composition is preferably 70% or less, more preferably 50% or less, and even more preferably 40% or less. The higher the effective chlorine content of the cleaning composition, the more intensely heat is generated when water is added. In view of particularly inhibiting heat generation, the cleaning composition of the present invention is applied as a cleaning composition having a high effective chlorine content, and thereby provides a significant inhibitory effect on heat generation and is thus of great significance. The effective chlorine content (in terms of Cl₂) of the cleaning composition can also be calculated by using the iodine titration method as the effective chlorine content of the chlorine bleach described above. Specifically, iodine liberated by the reaction of active chlorine and potassium iodide is titrated with an aqueous sodium thiosulfate solution, and the effective chlorine content is calculated according to Equation 3 described above.

The method for producing a material containing solid chlorine bleach having a coating layer can be a known coating method. As the manufacturing device, at least one device selected from the group consisting of stirring devices, rolling granulation devices, fluidized bed granulation devices, and a combination of these devices can be used. Each of multiple steps can be performed by using a different processing device. In view of ease of processing, at least one device selected from the group consisting of rolling granulation devices, fluidized bed granulation devices, and a combination of these devices are preferred. Alternatively, the manufacturing method described in PTL 2 can also be used.

The material containing solid chlorine bleach having a coating layer is preferably in the form of powder or particles. The material preferably has an average particle size of 1 to 5000 μm, more preferably 10 to 3000 μm, and even more preferably 100 to 1500 μm. This average particle size can be measured by using the method for measuring the average particle size of the powder of the cleaning composition described below. Alternatively, the average particle size can also be measured by using the method described in PTL 2.

### Alkaline Compound

In this specification, an “alkaline compound” refers to a metal salt of an inorganic compound or an organic compound that exhibits alkalinity when dissolved in water. Examples of alkaline compounds include at least one member selected from the group consisting of metal salts of silicic acid, metal salts of phosphoric acid, hydroxides of alkali metals, hydroxides of alkaline earth metals, carbonates, hydrates thereof, and mixtures thereof. Preferable examples of metal salts are salts of alkali metals and salts of alkaline earth metals. In view of alkalinity strength, ease of availability, and ease of handling, the alkali compound is preferably an alkali metal salt. Among alkali metal salts, sodium salts and potassium salts are particularly preferred in view of solubility in water and ease of availability. The cleaning composition may contain two or more alkaline compounds in combination.

Examples of alkali metal hydroxides include at least one member selected from the group consisting of lithium hydroxide, sodium hydroxide, potassium hydroxide, and mixtures thereof. Examples of alkaline earth metal hydroxides include at least one member selected from the group consisting of beryllium hydroxide, calcium hydroxide, magnesium hydroxide, and mixtures thereof. Examples of carbonates include at least one member selected from the group consisting of sodium carbonate (which may be referred to below as “soda ash”), sodium bicarbonate (which may be referred to below as “baking soda”), potassium carbonate, potassium bicarbonate, ammonium carbonate, sodium sesquicarbonate, and mixtures thereof.

Among these alkaline compounds, metal salts of silicic acid and metal salts of phosphoric acid are preferred. Preferable examples of metal salts of silicates include at least one member selected from the group consisting of orthosilicate metal salts, hydrates of orthosilicate metal salts, metasilicate metal salts, hydrates of metasilicate metal salts, and mixtures thereof. Examples of metal salts of phosphoric acid include at least one member selected from the group consisting of metal hydrogen phosphate, metal phosphate, metal pyrophosphate, metal tripolyphosphate, metal tetrapolyphosphate, metal pentapolyphosphate, metal metaphosphate, hydrates thereof, and mixtures thereof. The metal salts are preferably metal salts of alkali metals or alkaline earth metals. In view of alkaline strength, ease of availability, and ease of handling, alkali metal salts are preferred. Among alkali metal salts, sodium salts and potassium salts are particularly preferred in view of solubility in water and ease of availability.

In view of ease of handling, ease of availability, and alkaline strength, metal salts of silicic acid are preferably sodium metasilicate and hydrates of sodium metasilicate. Hydrates of sodium metasilicate are more preferably at least one member selected from the group consisting of sodium metasilicate pentahydrate, sodium metasilicate nonahydrate, and mixtures thereof.

In view of ease of handling, ease of availability, and alkalinity strength, metal salts of phosphoric acid are preferably sodium tripolyphosphate, sodium diphosphate, sodium metaphosphate, and hydrates thereof. Hydrates of sodium diphosphate are preferably sodium diphosphate decahydrate. Such metal salts of silicic acid and metal salts of phosphoric acid may be used alone or in a combination of two or more.

The cleaning composition of the present invention, which contains an alkaline compound, has excellent effects of removing dirt, bleaching, etc. based on alkalinity.

In view of improving the effects of removing dirt and bleaching, etc. based on alkalinity and in view of providing a higher cleaning effect based on the presence of solid chlorine bleach with an alkaline compound than the effect achieved by using only the alkaline compound, the content of the alkaline compound (excluding bound water if the alkaline compound contains bound water) in the cleaning composition is usually 5 wt. % or more, preferably 5 to 90 wt. %, more preferably 10 to 80 wt. %, and even more preferably 15 to 75 wt. %, based on the total weight of the entire cleaning composition taken as 100 wt. %.

The alkaline compound is usually a solid and preferably in the form of powder or particles. The alkaline compound preferably has an average particle size of 1 to 5000 μm, more preferably 10 to 3000 μm, and even more preferably 100 to 2000 μm. The average particle size can be measured by using the method for measuring the average particle size of the cleaning composition powder described below.

### Ratio of the Effective Chlorine Content to the Alkaline Compound Content in the Cleaning Composition

The solid chlorine bleach and the alkaline compound in the cleaning composition of the present invention are both essential components of the cleaning composition of the present invention, which contribute to cleaning effects. Further, the effective chlorine provided by the solid chlorine bleach and the alkalinity provided by the alkaline compound are considered to individually contribute to cleaning based on their different effects. Accordingly, if the content of only one of these two components is extremely high, the effect of the present invention may not be fully obtained. Therefore, the ratio of the effective chlorine content to the alkaline compound in the cleaning composition is preferably within a certain range. The ratio of the effective chlorine content to the alkaline compound content is defined by dividing the effective chlorine content (%) of the cleaning composition by the alkaline compound content (wt. %) in the net cleaning composition, excluding bound water. In view of obtaining a high cleaning effect, the ratio of the effective chlorine content to the alkaline compound content is preferably in the range of 0.1 to 0.8, more preferably 0.15 to 0.75, even more preferably 0.2 to 0.7, still even more preferably 0.25 to 0.7, and most preferably 0.3 to 0.7.

### Total of the Effective Chlorine Content and the Alkaline Compound Content in the Cleaning Composition

Since the solid chlorine bleach and the alkaline compound in the cleaning composition of the present invention are both essential components of the cleaning composition of the present invention that contribute to cleaning effects, it is preferable for both of the components to be present in predetermined amounts or more in the cleaning composition. The sum of the effective chlorine content and the alkaline compound content in the cleaning composition can be defined by totaling the effective chlorine content (%) and the net alkaline compound content (wt. %), excluding bound water, in the cleaning composition. In view of obtaining high cleaning effects, the sum total of the effective chlorine content and the alkaline compound content in the cleaning composition is preferably 40 or more, more preferably 45 or more, even more preferably 50 or more, still even more preferably 55 or more, and most preferably 60 or more.

### Water Content of the Cleaning Composition

The water present in the cleaning composition may be present as free water or bound water. Free water and bound water may be present as a mixture. Free water and bound water may be interchanged. In this specification, “water content” means the total content of free water and bound water. Although water can be contained in various forms such as free water and bound water, it is preferable for water to be contained in the form of bound water in view of keeping the composition solid and enhancing storage stability. In the present specification, “bound water” refers to water in a state in which water molecules are bound to a compound via hydrogen bonds. Although bound water may be called hydration water, crystalline water, etc., bound water, hydration water, and crystalline water shall mean the same.

Examples of metal salts of silicic acid include sodium metasilicate pentahydrate and sodium metasilicate nonahydrate. The water molecules in these compounds, in the form added to sodium metasilicate, such as pentahydrate and nonahydrate, can be considered bound water. For example, the molecular weight of sodium metasilicate is 122.06, the molecular weight of sodium metasilicate pentahydrate is 212.14, and the molecular weight of water molecules (pentahydrate) in sodium metasilicate pentahydrate is 90.08. The amount of water in sodium metasilicate pentahydrate is calculated to be 42.46 wt. % from 90.08/212.14×100. Accordingly, if the cleaning composition contains 50.0 wt. % of sodium metasilicate pentahydrate, the water content derived from sodium metasilicate pentahydrate in the cleaning composition is 21.2 wt. %. Similarly, when the water content of sodium metasilicate nonadihydrate is calculated to be 57.06 wt. %, and if the cleaning composition contains 50.0 wt. % of sodium metasilicate nonahydrate, the water content derived from sodium metasilicate nonahydrate in the cleaning composition is 28.5 wt. %.

When a compound with an unknown water content is included as a starting material, the measurement of the water content of the starting material may be defined by the weight loss when the starting material is dried to a constant weight by using a thermostatic dryer, a heating oven, or a thermogravimetric-differential thermal simultaneous analyzer (which may be referred to as TG-DTA), or may be calculated according to the following Equation 4.

$$Water content ( wt . \% ) = ( W 2 - W 1 ) \times 100 / W 2 \qquad ( Equation 4 )$$

W1: Weight (g) of sample after drying
W2: Weight (g) of sample before drying

The water content of the material containing solid chlorine bleach having a coating layer can be measured, for example, by the following method. A predetermined amount of the material containing solid chlorine bleach having a coating layer is placed on an enamel-coated baking tray, the tray is placed in a heating oven set at 110° C., and the material containing solid chlorine bleach having a coating layer is heat-dried to a constant weight. Using the weight loss of the material containing solid chlorine bleach having a coating layer, the water content can be calculated according to Equation 4. Free water evaporates when heat-dried at a temperature near the boiling point of water at normal pressure. Therefore, in the case of free water, the water content can be measured by heat-drying at a relatively low temperature of around 100° C.

The water content of the alkaline compound can be measured, for example, by the following method. Using the weight loss achieved by heating the alkaline compound up to, for example, 300° C. at a predetermined temperature rise rate, the weight loss of the alkaline compound can be calculated by TG-DTA according to Equation 4. In the case of bound water, the water in the compound may not be removed from the compound unless it is heated to a temperature above the boiling point of water. Therefore, heating up to a relatively high temperature may be necessary in some cases.

The water content of the cleaning composition can be determined from the water content and content ratio of each starting material in the cleaning composition. By measuring the water content of each starting material before incorporating the starting material into the cleaning composition, the water content in the cleaning composition can be obtained from the water content and content ratio of each starting material. Alternatively, the water content can also be determined from the cleaning composition. When the cleaning composition is heated, water content may not be accurately measured if the bleach, the alkaline compound, or other additives decompose and react upon heating. Therefore, it is desirable that the water content be measured below the temperature at which each starting material decomposes etc. The method for quantifying the water content in the cleaning composition can be appropriately selected from the methods described above or known methods. Even if there is an error in the results obtained by measurement methods, if the numerical value in the results obtained by any one of the measurement methods falls within the predetermined range, it can be regarded as satisfying the requirement even if the result measured by the other measurement methods falls outside the predetermined range.

When the water content in the cleaning composition is higher than the predetermined amount, although the effect of inhibiting heat generation upon addition of water to the cleaning composition can be obtained. However, the amounts of the active ingredients in the cleaning composition that directly contribute to cleaning, such as the solid chlorine bleach and the alkaline compound, are relatively reduced, and the packaging container of the cleaning composition is also more likely to swell and break, thus reducing storage stability. Accordingly, the water content of the cleaning composition must be 40 wt. % or less and is preferably 32 wt. % and more preferably 28 wt. % or less.

On the other hand, when the water content of the cleaning composition is below the predetermined amount, swelling and breakage of the packaging container of the cleaning composition is inhibited. Therefore, the water content of the cleaning composition may be 0 wt. % (that is, free of water). However, in view of fully obtaining the effect of inhibiting heat generation upon addition of water to the cleaning composition, the water content of the cleaning composition is preferably 0.1 wt. % or more, more preferably 0.8 wt. % or more, even more preferably 5 wt. % or more, and particularly preferably 10 wt. 8 or more.

That is, in view of inhibiting heat generation when adding water to the cleaning inhibiting, in view of inhibiting swelling and breakage of the packaging container containing the cleaning composition, and in view of maintaining the effective chlorine content as an active ingredient of the bleach in the cleaning composition over a long period of time, the water content of the cleaning composition is preferably within the predetermined range.

The water in the cleaning composition can be in the form of free water or bound water. The source of the water can be selected from various sources, such as free water or bound water in the compound contained in the cleaning composition. The water is preferably sourced from the bound water contained in the alkaline compound. The mechanism of inhibiting heat generation upon addition of water to the cleaning composition is presumably a synergetic effect of: the inhibition of reactivity between the solid chlorine bleach and the alkaline compound based on using the material containing solid chlorine bleach having a coating layer; and the inhibition of heat build-up by the water contained beforehand in the composition. Therefore, the bound water that directly binds to the alkaline compound, which is the source of heat generation, presumably plays an important effect. The ratio of the water derived from bound water contained in the alkaline compound is preferably high in terms of water content in the cleaning composition. The proportion of the water derived from the alkaline compound (bound water) is preferably 60 wt. % or more, more preferably 70 wt. % or more, and even more preferably 80 wt. % or more, based on the total weight of the water content of the cleaning composition taken as 100 wt. 8. Note that the effect of the present invention is not limited by this presumed mechanism.

### Dosage Form of the Coating Composition

The cleaning composition of the present invention is a solid and can be formulated into a powder, tablet, or solid dosage form. Powder, tablet, and solid dosage forms can also be combined. Further, the powder, tablets, and solids can each be formed as a composition containing several components. Some of the components may be in the form of a powder, and specific components that are identical to or different from the powder may be formed into tablets or a solid, and the powder and the tablets or solid may be used in combination. In view of quickly dissolving in water and providing effects, the cleaning composition of the present invention is preferably formed into a powder. The powder can be prepared by mixing powder starting materials of multiple components containing the material containing solid chlorine bleach having a coating layer and the alkaline compound by using a mixer or like commonly known methods, or by omitting the mixing step and directly placing the multiple starting materials into a packaging material . . .

In this specification, “powder” means clusters of particles. The shape of the particles is not particularly limited and includes, for example, irregular shapes, spheres, and rotational ellipsoids. Examples of the powder includes those obtained by secondarily processing powder into granules, for example, the case in which fine powders are processed by a known method such as fluidized bed granulation, or the case in which fine powders are compression-molded by a known method such as a Chilsonator and then pulverized. The starting compounds may be mixed beforehand and then subjected to secondary processing, such as granulation; or the starting compounds may be subjected to secondary processing, such as granulation, beforehand and then mixed to prepare a cleaning composition.

The power preferably has an average particle size of 1 to 5000 μm, more preferably 10 to 3000 μm, and even more preferably 100 to 1500 μm. If the average particle size is 5000 μm or less, the cleaning composition in the form of a powder is not overly large and is easy to handle. Furthermore, when used directly for cleaning or bleaching, the powder is easy to use because it can be directly placed into a drainage port etc. with a small opening. When the average particle size is 1 μm or more, the powder is easy to use as it is less likely to be scattered by slight wind or static electricity during handling.

The average particle size can be measured in the following manner. By using a 13-stage sifter with mesh openings of 75 μm, 106 μm, 150 μm, 250 μm, 425 μm, 600 μm, 710 μm, 850 μm, 1000 μm, 1180 μm, 1400 μm, 1700 μm, and 2000 μm, and a receiving saucer, each sieve of the sifter is stacked above the receiving saucer in such a manner that a sieve with a larger mesh opening is positioned at an upper stage. The sample is placed on the uppermost sieve with a mesh opening of 2000 μm, and the sieves are stacked above the receiving saucer in such a manner that a sieve with a larger mesh opening is positioned at an upper stage. The stacked sieves are set on a sieve shaker and shaken for 10 minutes for sieving. The sieve shaker may be used at a frequency of 3600 vibrations/minute and at an amplitude of 1 mm. To measure the particle size distribution, the methods and instruments (sieves) described in JIS Z 8815 and JIS Z 8801 may be used.

Examples of sieve shakers that can be used include, but are not limited to, “AS200 Control” produced by Retsch. When a sieve shaker is not available, the stacked sieves are supported with one hand and the sieve frame is tapped at a rate of approximately 120 times per minute. Occasionally, the sieve is positioned horizontally and the sieve frame is tapped hard several times. This operation is repeated to fully sift the sample. In the case where the sample is agglomerated due to static electricity or the like or in the case where fine powder adheres to the inside or back surface of the sieve, the sample is gently loosened with a brush, and the sieving operation is repeated. The sample that has passed through the sieve mesh is regarded as sieved-down. The sieved-down refers to a test sample that has passed through the sieve mesh by the end of sieving.

In the case where the sample contains particles having a particle size of larger than 2000 μm, multiple sieves with gradually increased mesh openings beyond 2000 μm may be added. For example, sieves with mesh openings of 2360 μm, 2800 μm, 3350 μm, 4000 μm, 4750 μm, 5600 μm, or larger may be added. In the case where the sample contains large amounts of particles having a particle size of 75 μm or less, sieves having gradually decreased mesh openings below 75 μm may be added. For example, sieves with mesh openings of 63 μm, 53 μm, 45 μm, 38 μm, or smaller may be added. Sieves with other mesh openings can also be selected.

The weight of particles remaining on each sieve and on the receiving saucer is measured and the weight percentage (%) of particles on each sieve is calculated. The weight percentage of particles is integrated by adding up the weight percentages of the particles on the sieves with smaller mesh openings in ascending order from the receiving saucer. If the mesh opening of the first sieve that achieves an integrated weight percentage of 50% or more is a μm, the mesh opening of the sieve one stage larger than a μm is b μm, the weight percentage integrated from the receiving saucer to the sieve with an opening mesh of a μm is cs, and the weight percentage of particles on the sieve with an opening mesh of a μm is d %, the average particle size can be obtained according to the following Equation 5.

$$Average particle size ( μm ) = {10}^{S} \qquad ( Equation 5 )$$

$$S = \frac{50 - ( c - \frac{d}{log b - log a} \times log b )}{\frac{d}{log b - log a}}$$

pH of aqueous solution of the cleaning composition Due to the relatively high concentration of the alkaline compound, the cleaning composition of the present invention has an alkaline pH when dissolved in water. A 1 wt. % aqueous solution of the cleaning composition has a pH of 9 or higher. In view of better removal of dirt and enhanced cleaning effects, such as bleaching, based on alkalinity, a 1 wt. % aqueous solution of the cleaning composition of the present invention has a pH of 9 or higher, preferably a pH of 10 or higher, more preferably a pH of 10.5 or higher, and even more preferably a pH of 11.5 or higher.

### Other Additives

The cleaning composition of the present invention can further contain various compounds beneficial for cleaning. The cleaning composition of the present invention can contain other additives, such as organic acids, surfactants, chelating agents (metal ion scavengers), organic polymers, perfumes, dyes, enzymes, and inorganic substances, as long as the effect of the present invention is not impaired. Liquid additives as well as solid additives can be used. For example, liquid additives can be mixed beforehand with a porous inorganic powder, such as zeolites, and the liquid component may be supported on an inorganic substance and then incorporated.

Examples of organic acids include, but are not limited to, at least one member selected from the group consisting of oxalic acid, malonic acid, succinic acid, fumaric acid, maleic acid, D-tartaric acid, L-tartaric acid, D-malic acid, L-malic acid, D-aspartic acid, L-aspartic acid, glutaric acid, D-glutamic acid, L-glutamic acid, formic acid, acetic acid, propionic acid, butyric acid, valeric acid, hexanoic acid, heptanoic acid, octanoic acid, nonanoic acid, decanoic acid, undecanoic acid, dodecanoic acid, myristic acid, stearic acid, palmitic acid, citric acid, and mixtures thereof. In view of being a solid and ease of handleability at normal temperature and pressure, preferable examples of organic acids are at least one member selected from the group consisting of oxalic acid, malonic acid, succinic acid, fumaric acid, maleic acid, D-tartaric acid, L-tartaric acid, D-malic acid, L-malic acid, D-aspartic acid, L-aspartic acid, glutaric acid, D-glutamic acid, L-glutamic acid, citric acid, and mixtures thereof. In view of excellent blending stability with the solid chlorine bleach such as sodium dichloroisocyanurate (hypochlorous acid generating source), more preferable examples of organic acids are at least one member selected from succinic acid, fumaric acid, and mixtures thereof.

Examples of surfactants that can be used include anionic surfactants, non-ionic surfactants, cationic surfactants, and amphoteric surfactants. In view of ease of availability etc., anionic surfactants are preferred. The incorporation of a surfactant not only facilitates contact of the cleaning components with the object to be cleaned, but also the surfactant itself contributes to removal of dirt from the object to be cleaned.

When the coating layer of the material containing solid chlorine bleach having a coating layer contains a surfactant, the surfactant content of the cleaning composition, including the surfactant contained in the coating layer, is preferably 0.1 wt. % or more, more preferably 1 wt. % or more, and even more preferably 2 wt. % or more, based on the weight of the cleaning composition, in view of obtaining sufficient surfactant effects and increasing the amount of foaming.

An excessively high surfactant content results in a small contribution to cleaning and the content of other cleaning components may be limited. Accordingly, the surfactant content of the cleaning composition is preferably 20 wt. % or less, more preferably 10 wt. % or less, and even more preferably 8 wt. % or less, based on the weight of the cleaning composition.

Alternatively, the surfactant may not be incorporated into the cleaning composition and may be added separately to a water-filled portion of the object to be cleaned. For example, the surfactant may be added beforehand to a water-filled portion in contact with the object to be cleaned and then cleaning composition may be added. In this case, the amount of surfactant to be added separately is not particularly limited, and can be, for example, in the same range as in the case of incorporating the surfactant into the cleaning composition. Examples of usable surfactants are at least one member selected from the group consisting of anionic surfactants, non-ionic surfactants, cationic surfactants, amphoteric surfactants, and mixtures thereof.

Examples of anionic surfactants include at least one member selected from the group consisting of: fatty acid salts such as potassium oleate soap, castor oil potassium soap, semi-hardened beef tallow fatty acid sodium soap, and semi-hardened beef tallow fatty acid potassium soap; alkyl sulfate ester salts such as sodium lauryl sulfate, sodium higher alcohol sulfate, triethanolamine lauryl sulfate, and ammonium lauryl sulfate; alkylbenzene sulfonates such as sodium C₁₂-C₁₄ branched or linear alkylbenzene sulfonates; sulfonates such as sodium C₁₄-C₁₈ α-olefin sulfonates; alkylnaphthalene sulfonates such as sodium alkylnaphthalene sulfonate; dialkylsulfosuccinates such as sodium dialkylsulfosuccinate; alkyl diaryl ether sulfonates such as sodium alkyl diphenyl ether disulfonate; alkyl phosphates such as potassium alkyl phosphate; naphthalene sulfonic acid formalin condensates such as sodium salts of β-naphthalene sulfonic acid formalin condensates; aromatic sulfonic acid formalin condensates, such as sodium salts of aromatic sulfonic acid formalin condensates; polyoxyethylene alkyl ether sulfate ester salts such as sodium polyoxyethylene lauryl ether sulfate; alkyl sulfosuccinates such as sodium alkyl sulfosuccinate; and mixtures of these.

Examples of non-ionic surfactants include at least one member selected from the group consisting of: alkyl ethers such as lauryl alcohol alkoxylate, lauryl alcohol ethoxylate, oleyl alcohol ethoxylate, and primary alcohol ethoxylate;

polyoxyethylene alkyl ethers such as polyoxyethylene cetyl ether, polyoxyethylene stearyl ether, polyoxyethylene oleyl ether, and polyoxyethylene higher alcohol ether; EO-PO block polymers such as polyoxyethylene-polyoxypropylene block polymers, reverse-type polyoxyethylene-polyoxypropylene block polymers, polyoxyethylene-polyoxypropylene condensates, polyoxyethylene-polyoxypropylene block polymers of ethylenediamine, reverse-type polyoxyethylene-polyoxypropylene block polymers of ethylenediamine; sorbitan fatty acid esters such as sorbitan laurate, sorbitan palmitate, sorbitan stearate, and sorbitan oleate; polyoxyethylene sorbitan fatty acid esters such as polyoxyethylene sorbitan laurate, polyoxyethylene sorbitan palmitate, polyoxyethylene sorbitan stearate, and polyoxyethylene sorbitan oleate; polyethylene glycol fatty acid esters such as polyethylene glycol laurate, polyethylene glycol stearate, and polyethylene glycol oleate; polyoxyethylene alkylamines such as polyoxyethylene laurylamine, polyoxyethylene stearylamine, and ethylenediamine-polyoxyethylene-polyoxypropylene block polymers; alkyl alkanolamides such as lauric acid monoethanolamide, lauric acid diethanolamide, myristic acid monoethanolamide, myristic acid diethanolamide, stearic acid monoethanolamide, stearic acid diethanolamide, coconut oil fatty acid monoethanolamide, and coconut oil fatty acid diethanolamide; glycerol fatty acid esters such as stearic acid monoglyceride, stearic acid diglyceride, palmitic acid monoglyceride, palmitic acid diglyceride, oleic acid monoglyceride, and oleic acid diglyceride; sucrose fatty acid esters; and mixtures of these.

Examples of cationic surfactants include at least one member selected from the group consisting of: alkyl amine salts such as coconut amine acetate and stearyl amine acetate; quaternary ammonium salts such as lauryl trimethyl ammonium salts, stearyl trimethyl ammonium salts, distearyl dimethyl ammonium salts, alkyl benzyl dimethyl ammonium salts, cetyltrimethyl ammonium salts, stearyl trimethyl ammonium salts, behenyl trimethyl ammonium salts, distearyl dimethyl ammonium salts, diisotetradecyldimethyl ammonium salts, cetylpyridinium chloride, benzethonium chloride, benzalkonium chloride, and didecyldimethylammonium chloride; and mixtures thereof.

Examples of amphoteric surfactants include alkyl betaines such as lauryl betaine, stearyl betaine, and 2-alkyl-N-carboxymethyl-N-hydroxyethyl imidazolinium betaine; amine oxides such as lauryl dimethylamine oxide; and at least one member selected from the group consisting of these surfactants.

In view of excellent blending stability with (a) solid chlorine bleach such as sodium dichloroisocyanurate, the surfactant is preferably an anionic surfactant. In view of particularly good blending stability with solid chlorine bleach and fineness of the foam formed, the surfactant is preferably at least one member selected from the group consisting of sodium linear alkylbenzene sulfonate, sodium α-olefin sulfonate, sodium alkyl sulfate, and mixtures thereof.

Examples of organic polymers include at least one member selected from the group consisting of: polysaccharides such as carrageenan, guar gum, locust bean gum, alginic acid, alkali metal salts of alginic acid, dextrin, xanthan gum, pectin, starch or their derivatives; methylcellulose, carboxymethylcellulose, alkali metal salts of carboxymethylcellulose, ethyl cellulose, hydroxypropyl cellulose, hydroxyethyl cellulose, other cellulose derivatives, and mixtures thereof. Other examples include at least one synthetic polymers selected from the group consisting of polyvinyl alcohol, polyacrylamide, polyethylene glycol, polyacrylic acid, polymaleic acid, olefin-maleic anhydride copolymers, acrylic acid-maleic acid copolymers, acrylic acid-sulfonic acid copolymers, diallyldimethylammonium polymers, diallyldimethylammonium-acrylic acid copolymers, diallylmethylamine-maleic acid copolymers, alkali metal salts thereof, halides thereof, and mixtures thereof. Multiple organic polymers may be used in a combination.

Among the organic polymers, polysaccharides are preferred in view of the effect of preventing re-adhesion of dirt. Among the polysaccharides, in view of blending stability with the solid chlorine bleach, for example, at least one member selected from the group consisting of carrageenan, guar gum, locust bean gum, xanthan gum, and mixtures thereof is preferred, and guar gum is more preferred. In view of imparting dispersibility to hardness components contained in water, synthetic polymers are preferred. Among the synthetic polymers, for example, at least one member selected from the group consisting of polyacrylic acid, polymaleic acid, olefin-maleic anhydride copolymers, acrylic acid-maleic acid copolymers, alkali metal salts thereof, and mixtures thereof are preferred. Such synthetic polymers and alkali metal salts thereof preferably have a weight average molecular weight of 5000 or more and 200000 or less, and more preferably 10000 or more and 180000 or less.

In view of preventing re-adhesion of dirt and avoiding an excessively increased water viscosity when the cleaning composition is dissolved in water, when the cleaning composition contains a polysaccharide, the amount of polysaccharide is preferably in the range of 0.01 to 10 wt. %, more preferably 0.1 to 7 wt. %, and even more preferably 0.5 to 5 wt. %, based on the weight of the cleaning composition. In view of obtaining sufficient dispersion of hardness components, the synthetic polymer content of the cleaning composition is preferably in the range of 0.1 to 80 wt. %, more preferably 1 to 60 wt. %, and even more preferably 1 to 40 wt. %, based on the total weight of the cleaning composition.

The organic polymer may not be incorporated into the cleaning composition but may be added separately to the water-filled portion of the object to be cleaned. For example, the organic polymer may be added beforehand to the water-filled portion in contact with the object to be cleaned and then the cleaning composition may be added. In this case, the amount of organic polymer to be added separately can be in the same range as when the organic polymer is incorporated into the cleaning composition.

Examples of chelating agents include at least one member selected from the group consisting of amino carboxylic acid derivatives such as nitrilotriacetic acid, ethylenediaminetetraacetic acid, β-alanine diacetic acid, aspartic acid diacetic acid, methylglycine diacetic acid, iminodisuccinic acid, glutamic acid diacetic acid, metal salts thereof, and hydrates thereof; hydroxyaminocarboxylic acids such as serine diacetic acid, hydroxyiminodisuccinic acid, hydroxyethyl ethylenediaminetriacetic acid, dihydroxyethylglycine, metal salts thereof, and hydrates thereof; phosphonocarboxylic acid derivatives such as tripolyphosphoric acid, 1-diphosphonic acid, α-methylphosphonosuccinic acid, 2-phosphonobutane-1,2-dicarboxylic acid, metal salts thereof, hydrates thereof; and mixtures of these. In terms of ease of availability, ease of handling, and metal ion-scavenging effect, at least one chelating agent selected from the group consisting of aminocarboxylic acid metal salts, hydrates of aminocarboxylic acid metal salts, hydroxyaminocarboxylic acid metal salts, hydrates of hydroxyaminocarboxylic acid metal salts, and mixtures thereof is preferred. A preferred example of metal salts of chelating agents is a sodium salt. In view of excellent stability with the solid chlorine bleach, the chelating agent is preferably 2.0 sodium nitrilotriacetate. When the cleaning composition contains a chelating agent, the chelating agent content of the cleaning composition must be above a predetermined amount in view of metal ion-scavenging effects. However, no further improvement in terms of the effect can be expected even if an excess of chelating agent is incorporated. Accordingly, the amount of chelating agent is preferably 0.1 to 80 wt. %, more preferably 1 to 60 wt. %, and even more preferably 1 to 40 wt. 8.

Examples of pigments include Scarlet G conc., Permanent Red GY, Seikafast (registered trademark) Carmine 3870, Seikafast Yellow 2200, Seikafast Yellow 2700 (B) (trade names, produced by Dainichiseika Color & Chemicals Mfg. Co., Ltd.), Acid Blue 9, Direct Yellow 12 (trade names, produced by Tokyo Chemical. Industry Co., Ltd.), Phthalocyanine Blue, Riboflavin (trade names, produced by Wako Pure Chemical Industries, Ltd.), and Ultramarine Blue (trade name, produced by Hayashi Pure Chemical Industries, Ltd.). Such pigments can be incorporated singly or in a combination of two or more. The pigment content of the cleaning composition is preferably 0.1 to 5 wt. %.

Examples of fragrances that can be used include natural fragrances and synthetic fragrances. For example, fragrances having various scents, such as mint, lime, and citrus, can be used. The fragrance content of the cleaning composition is preferably 0.1 to 8 wt. %.

Examples of enzymes that can be used include various enzymes useful for cleaning.

Examples of inorganic substances (excluding alkaline compounds) include sulfates, acetates, chlorides of alkali metals, aluminium sulfates, siloxanes, clay-like minerals, and boron compounds. When the cleaning composition contains an inorganic material (excluding alkaline compounds), the inorganic material content of the cleaning composition is preferably 0.1 to 60 wt. %, more preferably 1 to 40 wt. %, and even more preferably 1 to 20 wt. %, based on the weight of the cleaning composition, from the viewpoint that an excessively low content of the inorganic material in the cleaning composition fails to provide the intended effect, whereas an excessively high content of the inorganic material limits the contents of the bleach and the alkaline compound.

Examples of sulfates include alkali metal salts of sulfuric acid, such as sodium sulfate and potassium sulfate; and alkaline earth metal salts of sulfuric acid such as magnesium sulfate and calcium sulfate. Examples of acetates include alkali metal salts of acetic acid, such as sodium acetate and potassium acetate; and alkaline earth metal salts of acetic acid, such as magnesium acetate and calcium acetate. Examples of alkali metal chlorides include sodium chloride and potassium chloride. Examples of aluminium sulfate salts include potassium aluminium sulfate (which may be referred to as alum). Examples of clay minerals include hectorite. Examples of boron compounds include borax, boric acid, metaboric acid, and boron oxide. Examples of siloxanes include dimethylpolysiloxane. These inorganic substances may be incorporated into the cleaning composition singly or in a combination of two or more.

### Preferred Embodiments of the Cleaning Composition

In view of solubility in water, the cleaning composition of the present invention is preferably in the form of a powder. Preferable examples of the solid chlorine bleach in the material containing solid chlorine bleach having a coating layer include sodium dichloroisocyanurate, hydrates of sodium dichloroisocyanurate, and potassium dichloroisocyanurate; and sodium dichloroisocyanurate is more preferred.

In view of good solubility in water, the coating layer of the material containing solid chloride bleach having a coating layer is preferably a metal salt of carboxylic acid. The metal salt of carboxylic acid is, for example, at least one member selected from the group consisting of metal salts of aromatic carboxylic acids, alkali metal salts of acyclic dicarboxylic acids, alkali metal salts of acyclic monocarboxylic acids, and mixtures thereof. Metal salts of aromatic carboxylic acids are particularly preferred because they are easy to process as a coating layer and are readily available.

Preferable examples of metal salts of aromatic carboxylic acids are at least one member selected from the group consisting of metal salts of benzoic acid, ortho-phthalic acid, meta-phthalic acid, para-phthalic acid, trimellitic acid, and para-t-butylbenzoic acid; and mixtures thereof. Examples of metal salts include alkali metal salts, such as lithium salts, sodium salts, and potassium salts; and alkali earth metal salts such as calcium salts. In view of ease of availability, alkali metal salts are preferred. In view of solubility in water, sodium salts and potassium salts are more preferred. Particularly preferable examples of metal salts of aromatic carboxylic acids are at least one member selected from the group consisting of alkali metal salts of benzoic acid, alkali metal salts of para-t-butylbenzoic acid, and mixtures thereof. Preferable examples of metal salts of aromatic carboxylic acids are sodium benzoate and sodium para-t-butylbenzoate.

Preferable examples of metal salts of acyclic dicarboxylic acids are at least one member selected from the group consisting of metal salts of succinic acid, fumaric acid, maleic acid, adipic acid, pimelic acid, suberic acid, azelaic acid, sebacic acid, undecanedioic acid, dodecanedioic acid, tetradecanedioic acid, and mixtures thereof. Preferable examples of metal salts include alkali metal salts. In view of solubility in water, sodium salts and potassium salts are more preferred. Examples of metal salts of acyclic dicarboxylic acids include disodium sebacate, disodium undecanedioate, disodium dodecanedioate, and disodium tetradecanedioate.

Examples of metal salts of acyclic dicarboxylic acids are at least one member selected from the group consisting of metal salts of hexanoic acid (caproic acid), heptanoic acid (enanthate), octanoic acid, nonanoic acid, decanoic acid, dodecanoic acid, lauric acid, myristic acid, palmitic acid, stearic acid, arachidic acid, behenic acid, oleic acid, linoleic acid, linolenic acid, acrylic acid, methacrylic acid, isobutyric acid, and isovaleric acid. The metal salts are preferably alkali metal. In view of solubility in water, sodium salts and potassium salts are even more preferred. Preferable examples of metal salts of acyclic monocarboxylic acids include sodium hexanoate, sodium heptanoate, sodium octanoate, sodium nonanoate, sodium decanoate, sodium dodecanoate, sodium laurate, and sodium myristate.

Preferable examples of other carboxylic acid salts are metal salts of citric acid. Preferable examples of metal salts are alkali metal salts. In view of solubility in water, sodium salts and potassium salts are more preferred.

Such metal salts of aromatic carboxylic acids, metal salts of acyclic dicarboxylic acids, and metal salts of acyclic monocarboxylic acids may be used singly or in a combination of two or more of such compounds.

Preferable examples of alkaline compounds that can be used in the present invention include metasilicate metal salts, hydrates of metasilicate metal salts, and hydroxides of alkali metals. Preferable examples of metal salts are alkali metal salts such as sodium salts and potassium salts. Preferable examples of metasilicate metal salts include sodium metasilicate. Preferable examples of hydrates of metasilicate metal salts are sodium metasilicate pentahydrate and sodium metasilicate nonahydrate.

The water that can be used in the present invention is preferably bound water. In particular, sodium metasilicate pentahydrate and sodium metasilicate nonahydrate are preferable as alkaline compounds having bound water. Sodium dichloroisocyanurate hydrate can also be used as solid chlorine bleach having bound water.

### Method for Producing the Material Containing Solid Chlorine Bleach Having a Coating Layer

The material containing solid chlorine bleach having a coating layer of the present invention can be produced by a known method. For example, the compound used to form the coating layer is dissolved in a solvent, such as water or alcohol, to form a solution. Solid chlorine bleach is allowed to flow in a rolling granulator or a fluidized bed granulator. The aqueous solution of the compound used to form the coating layer is splayed over the solid chlorine bleach. A coating layer can thereby be formed on the solid chlorine bleach. Other production methods can also be used. The manufacturing method described in PTL 2 can also be used.

### Method for Producing the Cleaning Composition

The cleaning composition of the present invention can be produced by mixing the material containing solid chlorine bleach having a coating layer and the alkaline compound described above, optionally with other additives. The components to be contained in the cleaning composition can be placed in a known mixer and further packaged in small containers, such as films, pouches, or bottles. The components to be contained in the cleaning composition can also be directly placed in small containers, such as film, pouches, or bottles, without using a mixer.

### Method for Using the Cleaning Composition

The cleaning composition of the present invention is placed into an object to be cleaned that has a water-filled portion to thereby efficiently clean or bleach dirt on the object to be cleaned. Examples of the object to be cleaned include hard surfaces in the vicinity of water that are in contact with water and where dirt tends to accumulate. Specific examples include water-filled portions in kitchens, washrooms, bathrooms, toilets, etc., drainage ports, the inside of drainpipes, etc., and washing drums of washing machines, including drum-type washing machines and vertical washing machines.

The cleaning composition and the cleaning method of the present invention can be used safely because the heat generation that would occur when the cleaning composition comes into contact with a small amount of water is reduced. Further, the cleaning composition of the present invention is suitable for distribution because with the cleaning composition in the state of being packaged, swelling and breakage of the packaging container is inhibited. The cleaning composition of the present invention is easy to handle because active ingredients of the bleach are inhibited from deterioration and can be stored for a longer period of time. Further, the cleaning composition of the present invention has excellent cleaning and bleaching effects, based on exhibiting alkalinity when dissolved in water and the presence of solid chlorine bleach therein. Further, when the object to be cleaned is a metal, the cleaning composition of the present invention can also inhibit the solid chlorine bleach from rusting the metal.

When the cleaning composition and the cleaning method of the present invention are used in the washing machine drum of a washing machine, the cleaning composition is placed into the water accumulated beforehand in the washing machine drum and the washing machine is run, whereby mold and biofilm inside or behind the washing machine drum can be efficiently removed. When used in a drum-type washing machine, the cleaning composition can be fed into the washing machine drum and cleaning can be performed by using a cleaning mode provided in the washing machine, such as a drum-cleaning course. Cleaning the washing machine drum not only removes mold soiling, biofilm, soap scum, and like dirt adhering to the washing machine drum, but the inside of the washing machine drum also becomes clean, which reduces odor transfer from the washing machine drum to the laundry. Therefore, dampness odor from the laundry dried by, for example, a washing machine with a drying function can be reduced.

When used to clean a drainpipe, the cleaning composition can be added from the drainage port and then water can be poured into the drainpipe to clean the inside of the drainpipe. The cleaning composition dissolved in water beforehand may be poured into the drainpipe, or if water has already accumulated inside the drainpipe, the cleaning can be carried out by simply pouring the cleaning composition inside. Further, the cleaning composition of the present invention can also be used in an area where an accumulation of water is usually not present, as long as it is an area to which the cleaning composition can be fed in combination with water. Examples include drainage ports in bathrooms etc., bathtubs, and kitchen sinks.

In order for the effect of the cleaning composition of the present invention to be exhibited effectively, the concentration of the cleaning composition in the aqueous solution after feeding is preferably in the range of 0.01 to 100 g/L, more preferably 0.1 to 50 g/L, and even more preferably 1 to 25 g/L. The higher the concentration of the cleaning composition, the more easily the cleaning effects are obtained. However, an excess of the cleaning composition added cannot be expected to provide further improvement in cleaning effects.

In order for the cleaning composition of the present invention to exhibit bleaching and cleaning effects on the object to be cleaned, the effective chlorine concentration in the aqueous solution of the cleaning composition after feeding into water is preferably 100 ppm or more, more preferably 500 ppm or more, and even more preferably 1000 ppm or more.

With respect to the method for using the cleaning composition, if the object to be cleaned already has an accumulation of water, such as a water-filled portion of a toilet bowel or a drainage port, the cleaning composition can simply be thrown directly into the water. If the object to be cleaned is configured to be able to freely hold water therein, such as a sink, a bathtub, or a washing machine, the cleaning composition may be added after filling the object with water, or water may be added after the cleaning composition is placed. That is, the object to be cleaned can be cleaned by performing the step of dissolving the cleaning composition in water and the step of bringing the aqueous solution of the cleaning composition into contact with the object to be cleaned. The cleaning method of the present invention can be performing by the step of individually adding, to water, components that may be contained in the cleaning composition, i.e., a material containing solid chloride bleach having a coating layer and an alkaline compound and optionally other additives, and dissolving each component in the water; and the step of bringing the water containing the components as dissolved therein into contact with the object to be cleaned.

### Water Content of Material Containing Solid Chlorine Bleach

The water content of the material containing solid chlorine bleach having a coating layer can be measured, for example, by the following method. A predetermined amount of the material containing solid chlorine bleach having a coating layer is put on an enamel-coated baking tray, placed in a heating oven set at 110° C., and heat-dried until it has reached a constant weight to determine the weight loss. Using the weight loss, the water content of the solid chlorine bleach having a coating layer can be calculated according to Equation 4. Free water evaporates when heat-dried at a temperature near the boiling point of water at normal pressure. Therefore, in the case of free water, the water content can be measured by heat-drying at a relatively low temperature of around 100° C.

### Water Content of Alkaline Compound

For example, using a hydrate of a silicic acid metal salt as an example, the water content of the alkaline compound can be determined by the method described below. Examples of hydrates of silicic acid metal salts include compounds such as sodium metasilicate pentahydrate and sodium metasilicate nonahydrate. The water molecules of these compounds in the form of being added to sodium metasilicate, such as sodium metasilicate pentahydrate and sodium metasilicate nonahydrate, can be considered to be bonded water. Sodium metasilicate has a molecular weight of 122.06. Sodium metasilicate pentahydrate has a molecular weight of 212.14. The molecular weight of water molecules (pentahydrate) in sodium metasilicate pentahydrate is 90.08. The water content of sodium metasilicate pentahydrate is calculated to be 42.46 wt. % from 90.08/212.14×100. Similarly, the water content of sodium metasilicate nonahydrate is calculated to be 57.06 wt. %.

When the water content is unknown, it can be determined, for example, by the following method. An alkaline compound is subjected to TG-DTA. For example, a sample is set to an aluminum sample pan and the temperature is raised at a predetermined temperature rise rate of 5° C./min, while feeding nitrogen gas at a flow rate of 200 ml/min to create a nitrogen atmosphere, and the temperature is raised to about 300° C. Using the weight loss calculated in terms of alumina as a reference, the water content can be calculated according to Equation 4. For bound water, heat-drying at relatively high temperatures may be necessary because water in the compound cannot be removed without heating to temperatures above the boiling point of water.

Compounds containing free water may also be measured by using TG-DTA. The measurement conditions for TG-DTA may be appropriately set according to the properties of the compound to be measured. The cleaning composition may be directly subjected to TG-DTA analysis to measure the water content of the cleaning composition.

PTL 2 (WO2017/183726) and US2019/0153363 corresponding thereto are incorporated herein by reference in their entireties.

### EXAMPLES

The present invention is described specifically with reference to Examples and Comparative Examples. However, the present the invention is not limited to these Examples. The starting materials and experimental equipment used in the Examples and Comparative Examples are as follows.

Starting materials
Sodium dichloroisocyanurate: produced by Shikoku Chemicals Corporation, trade name “Neochlor 60G” (actual effective chlorine content: 63.0%, water content: 1.40 wt. %)
Sodium benzoate: a reagent (produced by Fujifilm Wako Pure Chemical Corporation)
Decanoic acid: a reagent (produced by Fujifilm Wako Pure Chemical Corporation)
Sodium hydroxide: a reagent (produced by Fujifilm Wako Pure Chemical Corporation)
Aqueous sodium decanoate solution: decanoic acid was dispersed in distilled water, and an equivalent amount of sodium hydroxide was added and stirred to thereby obtain an aqueous sodium decanoate solution (concentration of sodium decanoate: 20 wt. 8)
Sebacic acid: reagent (produced by Fujifilm Wako Pure Chemical Corporation)
Aqueous disodium sebacate solution: Sebacic acid is dissolved in distilled water, and an equivalent amount of sodium hydroxide was added and stirred to thereby obtain an aqueous disodium sebacate aqueous solution (concentration of disodium sebacate: 20 wt. %)
Sodium lauryl sulfate: trade name “Emar 10 PT,” produced by Kao Corporation
Sodium metasilicate (anhydrous): a reagent (produced by sigma-Aldrich, water content: 0.00 wt. % or less)
Sodium metasilicate pentahydrate: a reagent (produced by Sigma-Aldrich)
Sodium metasilicate nonahydrate: a reagent (produced by Fujifilm Wako Pure Chemical Corporation)
Sodium diphosphate decahydrate: a reagent (produced by Fujifilm Wako Pure Chemical Corporation),
Tetrasodium ethylenediaminetetraacetate dihydrate: a reagent (produced by Dojindo Laboratories)
Trisodium citrate dihydrate: a reagent (produced by Fujifilm Wako Pure Chemical Corporation)

### Materials

Aluminium-laminated film
Material composition (μm): PET12/AL7/CPP50

Equipment:
Sieve shaker:

AS200 Control, produced by Retsch
Rolling granulator: DPZ-1, produced by As One Corporation,
pH meter: F-51, produced by Horiba, Ltd.
pH electrode: 9615S-10D, produced by Horiba, Ltd.
TG-DTA: STA7200RV, produced by Hitachi High-Tech Science

Corporation
Drum-type washing machine: NA-VG740L, produced by Panasonic Corporation

### (1) Production of Materials Containing Solid Chlorine Bleach Having a Coating Layer

Material containing solid chlorine bleach having a coating layer 1

As a compound to be used for forming the coating layer, sodium benzoate was dissolved in water to prepare a 30 wt. %

aqueous coating solution of sodium benzoate. Sodium dichloroisocyanurate powder was placed in a rolling granulator, and the rolling granulator was rotated while heating at 60° C. The aqueous coating solution was sprayed over sodium dichloroisocyanurate flowing in the rolling granulator. When a predetermined amount of a coating layer had been formed, spraying was terminated, thus obtaining a material containing solid chlorine bleach having a coating layer 1. The material containing solid chlorine bleach having a coating layer 1 had an effective chlorine content of 44.8%, the percentage of the coating layer was 26.0 wt. %, the water content was 2.90 wt. %, and the average particle size was 855 μm.

### Material Containing Solid Chlorine Bleach Having a Coating Layer 2

As a compound to be used for forming the coating layer, a 20 wt. % aqueous solution of sodium decanoate was prepared and used as an aqueous coating solution. A material containing solid chlorine bleach having a coating layer 2 was produced in the same manner as in the material containing solid chlorine bleach having a coating layer 1 except that sodium decanoate was used. The material containing solid chlorine bleach having a coating layer 2 had an effective chlorine content of 47.0%, the percentage of the coating layer was 19.3 wt. %, and the water content was 5.59 wt. %. The average particle size was 1474 μm.

### Material Containing Solid Chlorine Bleach Having a Coating Layer 3

As a compound to be used for forming the coating layer, an 20 wt. % aqueous solution of disodium sebacate was prepared and used as an aqueous coating solution. A material containing solid chlorine bleach having a coating layer 3 was produced in the same manner as in the material containing solid chlorine bleach having a coating layer 1 except that disodium sebacate was used. The material containing solid chlorine bleach having a coating layer 3 had an effective chlorine content of 44.7%, the percentage of the coating layer was 25.5 wt. %, and the water content was 2.98 wt. 8. The average particle size was 680 μm.

### Material Containing Solid Chlorine Bleach Having a Coating Layer 4

As a compound to be used for forming the coating layer, sodium lauryl sulfate was dissolved in water to prepare a 20 wt. aqueous coating solution of sodium lauryl sulfate. A material containing solid chlorine bleach having a coating layer 4 was produced in the same manner as in the material containing solid chlorine bleach having a coating layer 1 except that sodium lauryl sulfate was used. The material containing solid chlorine bleach having a coating layer 4 had an effective chlorine content of 46.9%, the percentage of the coating layer was 23.0 wt. %, and the water content was 1.87 wt. %. The average particle size was 1247 μm.

### (2) Measurement of Water Content

### Water Content of Material Containing Solid Chlorine Bleach Having a Coating Layer

The water content of a material containing solid chlorine bleach having a coating layer was measured by the following method. A predetermined amount of a material containing solid chlorine bleach having a coating layer was placed in an enamel-coated baking tray and dried in an oven heated at 110° C. for 1 hour. After confirming that a constant weight has been reached, the weight loss was determined. Using the weight loss, the water content was calculated according to Equation 4.

### Water Content of Alkaline Compound

The water content of the alkaline compound was measured by the following method. Examples of metal salts of silicic acid include compounds such as sodium metasilicate pentahydrate and sodium metasilicate nonahydrate. The water molecules in such compounds in the form of being added to sodium metasilicate, such as pentahydrate and nonahydrate, can be considered to be bound water.

For example, sodium metasilicate has a molecular weight of 122.06, sodium metasilicate pentahydrate has a molecular weight of 212.14, and the molecular weight of the water molecules (pentahydrate) in sodium metasilicate pentahydrate is 90.08.

The water content of sodium metasilicate pentahydrate is calculated to be 42.4 wt. % from 90.08/212.14×100. Accordingly, the amount of water derived from sodium metasilicate pentahydrate in the cleaning composition can be calculated by multiplying the water content of sodium metasilicate pentahydrate by the sodium metasilicate pentahydrate content of the cleaning composition. For example, when the cleaning composition contains sodium metasilicate pentahydrate in an amount of 50.0 wt. %, the amount of water derived from sodium metasilicate pentahydrate in the cleaning composition is calculated to be 21.2 wt. %.

Similarly, the water content of sodium metasilicate nonahydrate is calculated to be 57.06 wt. %. The amount of water derived from sodium metasilicate nonahydrate in the cleaning composition can be calculated by multiplying the water content of sodium metasilicate nonahydrate by the sodium metasilicate nonahydrate content of the cleaning composition. For example, when the cleaning composition contains sodium metasilicate nonahydrate in an amount of 50.0 wt. %, the content of water derived from sodium metasilicate nonahydrate in the cleaning composition is 28.5 wt. %.

When the cleaning composition contains multiple alkaline compounds, the sum of the water content of these compounds is the water content of the alkaline compounds. When the hydrate content was unknown, the alkaline compound was placed on an aluminium sample pan, and weight loss was determined by TG-DTA when the temperature was raised to 300° C. at a temperature rise rate of 5° C./min and at a nitrogen purge gas flow of 200 ml/min. The water content was calculated according to Equation 4. Alumina was used as reference.

Sodium metasilicate pentahydrate had a water content of 42.46 wt. %. Sodium metasilicate nonahydrate had a water content of 57.06 wt. %. Sodium diphosphate decahydrate had a water content of 40.39 wt. %.

The water content of the other compounds was determined in the same manner as the method of determining the water content of the alkaline compound. Note that when the compound decomposed at a temperature of 300° C. or lower, the measurement conditions were appropriately set according to the properties of the compound, for example, by reducing the heating temperature and performing measurements.

### (3) Evaluation Method

The cleaning compositions obtained as described above were packaged in aluminium-laminate film to obtain packaged cleaning compositions.

The average particle size of the powder was measured by the method described in the “Powder” section of the present specification. The powders of the starting materials used in the present invention all had an average particle size in the range of 200 to 1000 μm.

### Heat Generation Test

6.8 g of the powdered cleaning compositions having the formulations shown below in Tables 1 to 8 were individually placed into 50 ml beakers. With a thermometer being placed in each beaker, 5 ml of distilled water (room temperature) was added and the temperature was recorded every 1 minute until 20 minutes had passed. The highest temperature among the measured temperatures for 20 minutes was taken as heat generation temperature Tom.

Tables 1 to 8 below show the results.

### Storage Stability Test; Change Over Time in Effective Chlorine Retention

30 g of powdered cleaning compositions having the formulations shown in Tables 1 to 8 were placed in aluminium-laminated film and hermetically sealed by heat sealing to obtain cleaning compositions packaged in a bag using aluminium-laminated film. The cleaning compositions were placed in an oven set at 50° C. and stored for 4 weeks. Four weeks after the start, each cleaning composition was removed from the aluminium-laminate film and mixed and ground so as to be uniform. The effective chlorine content was determined by the iodine titration method. The ratio of the effective chlorine content of the cleaning composition after the storage stability test to the effective chlorine content of the cleaning composition before the storage stability test was calculated as the effective chlorine retention. Tables 1 to 8 shows the results. When the aluminium-laminated film in which each cleaning composition had been hermetically packaged swelled and broke before 4 weeks had passed after placement into the oven, the test was terminated at that point of time, and the effective chlorine content at the time of bag breakage was recorded. When the package container is in the form of a bag, breakage may be referred to as bag breakage.

### Storage Stability Test; Evaluation of Swelling of the Packaging Container

30 g of powdered cleaning compositions having the formulations shown in Tables 1 to 8 were placed in aluminium-laminated film, hermetically sealed by heat sealing, and packaged in aluminium-laminated film in the same manner as in the measurement of the effective chlorine retention described above. The packaging containers containing the cleaning compositions were placed in an oven set at 50° C. and stored for 4 weeks. Four weeks after the start, the appearance of each packaging container was visually checked. When the packaging container swelled and broke (bag breakage occurred) or when the occurrence of swelling was clearly identified even though no bag breakage had occurred, it was assessed as “C.” When slight swelling of the packaging container was observed, it was assessed as “B.” When almost no swelling of the packaging container was observed, it was assessed as “A.”

### Measurement of pH

The powdered cleaning compositions having the formulations shown in Tables 1 to 8 were dissolved in distilled water to prepare 1 wt. % aqueous solutions, and the temperature of each aqueous solution was adjusted to 25° C. Using about 50 ml of each aqueous solution after stirring, the pH was measured with a pH meter. The pH meter was subjected to a three-point calibration using pH 4, pH 7, and pH 9 standard solutions immediately before the measurement.

Cleaning Test 1; Cleaning of Contaminated Cloth with Cleaning Composition

Powdered cleaning compositions having the formulations shown in Table 8 were dissolved in distilled water to prepare 0.02 wt. % aqueous cleaning solutions. The pH and effective chlorine concentration (mg/L) of each aqueous cleaning solution were measured.

Further, 800 ml of the aqueous cleaning solution was placed in a 1 L beaker, and half of the cloth area of a 5 cm×5 cm black tea-dyed cotton cloth (STC EMPA 167, produced by Nippon Shizai Co., Ltd.) was immersed in the aqueous cleaning solution and allowed to stand at 20° C. for 30 minutes. After 30 minutes, the cotton cloth was removed and dried at room temperature. A whiteness meter (Digital Whiteness Meter TC-6D, produced by Tokyo Denshoku) was used to measure the whiteness of the area immersed in the aqueous cleaning solution and the whiteness of the area not immersed. The whiteness of the area immersed in the aqueous cleaning solution reflects the bleaching effect of the aqueous cleaning solution, whereas the whiteness of the area not immersed reflects the color of the cotton cloth before cleaning. Accordingly, it can be considered that the greater the difference in whiteness between these areas, the higher the bleaching effect of the aqueous cleaning solution. Note that a higher value for whiteness means that the color of the target object is closer to white. For whiteness, JIS Z 8715 (Japanese Industrial Standard, “Colour specification-Whiteness”) and JIS Z 8722 (Japanese Industrial Standards, “Methods of colour measurement-Reflecting and transmitting objects”) may be referred to. The cotton cloth to be subjected to this test may also be appropriately selected from other cotton cloths that are different from the cloth described above in terms of dyeing method or material. When a whiteness meter is not available, the whiteness can be visually evaluated.

### Cleaning Test 2; Cleaning of Cut Pieces of Washing Machine Drum Using Cleaning Composition

Powdered cleaning compositions having the formulations shown in Table 8 were dissolved in distilled water to prepare 0.8 wt. % aqueous cleaning compositions. 105 ml of the aqueous cleaning solutions were individually placed in 125 L containers made of polypropylene (PP) resin. The resin washing drum of a well-used washing machine (National fully automatic washing machine NA-F42S1, produced by Matsushita Electric Industrial Co., Ltd.) on which black mold and dirt had been accumulated through actual use was cut into 5 cm×5 cm squares and used as test pieces. The test pieces were immersed in 25° C. aqueous cleaning solutions for 3 hours, and the condition of the test pieces after cleaning was visually assessed. When the majority of dirt was removed, the cleaning composition was assessed as A. When about half of the dirt was removed, the cleaning composition was assessed as B. When the majority of the dirt remained without being removed or no dirt was removed at all, the cleaning composition was assessed as C.

### Use Test of Washing Machine

Using the cleaning compositions packaged in aluminium-laminate film, a use test in a washing machine was performed. The aluminium-laminate film containing 200 g of the cleaning composition was opened, and the entire 200 g of the cleaning composition was placed into the washing drum of a drum-type washing machine (Panasonic, NA-VG740L). The washing drum was cleaned by selecting the “leave it to us” course or “drum cleaning course” on the washing machine panel. The inside of the washing drum during cleaning was observed through the door window, and the effluent after cleaning or the aqueous solution in the washing drum during cleaning was collected and the effective chlorine concentration and pH were measured.

In the present specification, the phrase “inhibit heat generation” means that when water is added to a predetermined amount of cleaning composition, the highest temperature achieved by temperature rise due to heat generation is lower than that of a reference.

The phrase “inhibit swelling and breakage of the packaging container” means that when the cleaning composition is sealed in a predetermined packaging container, the increase in volume of the packaging container is smaller than that of a comparative composition, or the time taken until part of the packaging container is broken is longer than that of the comparative composition, or the degree of breakage of the packaging container is smaller than that of a comparative composition.

The phrase “the chlorine bleach is stably maintained” means that after a cleaning composition is stored under predetermined conditions for a certain period of time, the effective chlorine retention rate of the chlorine bleach, which is an active ingredient, is higher than that of a comparative composition.

In the Comparative Examples, a tendency was observed for the heat generation to increase with a lower water content of the cleaning composition. Accordingly, in the Examples, cleaning compositions were prepared so as to have the same effective chlorine content and were compared with cleaning compositions in the Comparative Examples, which contained no material containing solid chlorine bleach having a coating layer and which were identical to those of the Examples in terms of kinds of compounds used as constituent components but are different only in the content ratio. If the highest temperature achieved due to the temperature rise of the cleaning composition in the Examples in which the water content of the cleaning composition is almost equal to or lower than that of the corresponding cleaning composition in the Comparative Examples, the cleaning composition of the Examples is considered to “inhibit heat generation.”

In the Comparative Examples, the degree of swelling and breakage of the packaging container tended to increase as the water content of the cleaning composition increased. Accordingly, in the Examples where the effective chlorine content of the cleaning compositions is the same and the water content of the cleaning compositions is almost equal to or higher than that of the cleaning compositions of the Comparative Examples, if the degree of swelling or breakage (bag breakage) of the packaging container is smaller or if it takes a longer time for swelling or breakage to occur, the cleaning composition of the Examples can be considered to “inhibit the swelling and breakage of the packaging container.”

Further, in the Comparative Examples, a tendency for the effective chlorine retention of the cleaning composition to decrease as the water content of the cleaning composition increased was observed. Accordingly, in the Examples where the water content of the cleaning compositions is almost equal to or larger than that of the cleaning compositions in the Comparative Examples, if the reduction in the effective chlorine retention of the cleaning compositions is inhibited, the cleaning compositions are considered to “have a high effective chlorine retention.”

### (4) Production and Evaluation of Cleaning Composition

### Examples 1 to 3 and Comparative Examples 1 to 3

Either solid chlorine bleach having a coating layer 1 or sodium dichloroisocyanurate, and sodium metasilicate (anhydrous) and/or sodium metasilicate pentahydrate were blended according to the formulations shown in Table 1 to prepare cleaning compositions with an effective chlorine content of 13.5%. These cleaning compositions were individually packaged in aluminium-laminated film. The water content of each cleaning composition, effective chlorine content, pH of the aqueous solution, heat generation temperature, and storage stability test results are as shown in Table 1.

TABLE 1

| | | | Example | Example | Example | Comp. | Comp. | Comp. |
|---|---|---|---|---|---|---|---|---|
| | | Formulation | 1 | 2 | 3 | Ex. 1 | Ex. 2 | Ex. 3 |
| Content | Solid | Solid chlorine bleach having a coating | 30.0 | 30.0 | 30.0 | | | |
| (wt. %) | chlorine | layer 1 | | | | | | |
| | bleach | Sodium dichloroisocyanurate | | | | 21.5 | 21.5 | 21.5 |
| | Alkaline | Sodium metasilicate (anhydrous) | 70.0 | 35.0 | | 78.5 | 43.2 | |
| | compound | Sodium metasilicate pentahydrate | | 35.0 | 70.0 | | 35.3 | 78.5 |
| Water content | Water content derived from solid chlorine bleach in the | | 0.870 | 0.870 | 0.870 | 0.301 | 0.301 | 0.301 |
| (wt. %) | cleaning composition (wt. %) | | | | | | | |
| | Water content derived from alkaline compound in the | | 0.00 | 14.9 | 29.7 | 0.00 | 15.0 | 33.3 |
| | cleaning composition (wt. %) | | | | | | | |
| | Total water content in the cleaning composition (wt. %) | | 0.87 | 15.8 | 30.6 | 0.30 | 15.3 | 33.6 |
| | Proportion of alkaline compound-derived water content in | | 0.0 | 94.3 | 97.1 | 0.0 | 98.0 | 99.1 |
| | the water content of the cleaning composition (wt. %) | | | | | | | |
| Effective chlorine | Effective chlorine content (%) in the cleaning composition | | 13.5 | 13.5 | 13.5 | 13.5 | 13.5 | 13.5 |
| content (%) | | | | | | | | |
| pH | pH of 1 wt. % aqueous solution | | 12.40 | 12.23 | 11.97 | 12.60 | 12.36 | 12.17 |
| Alkaline compound content, excluding hydration water, in the cleaning | | | 70.0 | 55.1 | 40.3 | 78.5 | 63.5 | 45.2 |
| composition (wt. %) | | | | | | | | |
| Ratio of effective chlorine content (%) / alkaline compound content (excluding | | | 0.19 | 0.25 | 0.33 | 0.17 | 0.21 | 0.30 |
| hydration water) (wt. %) in the cleaning composition | | | | | | | | |
| Total of effective chlorine content (%) and alkaline compound content (excluding | | | 83.5 | 68.6 | 53.8 | 92.0 | 77.0 | 58.7 |
| hydration water) (wt. %) in the cleaning composition | | | | | | | | |
| Heat generation | T_{5 ml} (6.8 g / 5 ml) (° C.) | | 35.5 | 29.8 | 26.2 | 82.6 | 44.4 | 34.0 |
| temperature (° C.) | | | | | | | | |
| Storage stability | Effective chlorine retention (%) (50° C.) (4 weeks) | | 99.0 | 98.0 | 97.0 | 98.0 | 52.0 *1 | 80.0 *2 |
| test | | | | | | | | |
| | Swelling or breakage of packaging container (bag | | A | A | A | A | B | B |
| | breakage) | | | | | | | |

*1: Bag breakage at 3 weeks; retention (%) after 3 weeks.
*2: Bag breakage in 3 days; retention (%) after 3 days.

The material containing solid chlorine bleach having a coating layer 1 had a water content of 2.90 wt. 8. Accordingly, when the cleaning composition contained 30.0 wt. % of the material containing solid chlorine bleach having a coating layer 1, the water content derived from the solid chlorine bleach in the cleaning composition was 0.870 wt. 8.

Further, the water content of sodium metasilicate pentahydrate was 42.5 wt. %. Accordingly, when the cleaning composition contains sodium metasilicate pentahydrate in an amount of 35.0 wt. % (Example 2) or 70.0 wt. % (Example 3), the cleaning compositions (of Examples 2 and 3) had a water content derived from the alkaline compound in the cleaning compositions of 14.9 wt. % and 29.7 wt. %, respectively.

The water content of the cleaning composition obtained in Example 1, which contained only sodium metasilicate (anhydrous) as an alkaline compound, is equal to the water content derived from the solid chlorine bleach. The water contents of the cleaning compositions in Examples 2 and 3 containing sodium metasilicate pentahydrate were each equal to the sum of the water content derived from the material containing solid chlorine bleach having a coating layer and the water content derived from the alkaline compound. The water contents of the cleaning compositions in Examples 2 and 3 were 15.8 wt. % and 30.6 wt. %, respectively. The water content of the cleaning compositions in Comparative Examples 1 to 3 can also be calculated using the same approach.

As shown in Table 1, in Examples 1 to 3, the heat generation temperature Tom tended to decrease as the water content of the cleaning composition increased, and the results showed that in all of the Examples, the effective chlorine retention decreased and swelling of the packaging container was inhibited.

On the other hand, in Comparative Examples 1 to 3 as well, a tendency was observed for the heat generation temperature to decrease as the water content in the cleaning composition increased. However, the heat generation temperature Tom exceeded 80° C. and high heat generation was observed in Comparative Example 1. In addition, in Comparative Examples 2 and 3, although there was a tendency for heat generation to be inhibited as the water content of the cleaning composition increased, a tendency for the effective chlorine retention to decrease and for swelling of the packaging container to occur was observed.

Further, a comparison of Example 1 with Comparative Example 1, a comparison of Example 2 with Comparative Example 2, and a comparison of Example 3 with Comparative Example 3, in each pair of which the water content of the cleaning composition is almost equivalent, clearly shows the compositions of the Examples are clearly different from those of the Comparative Examples in terms of the effects of inhibiting heat generation and inhibiting swelling of the packaging container. Accordingly, a comparison of Examples 1 to 3 with Comparative Examples 1 to 3 confirmed that even when the effective chlorine content of the cleaning composition is equivalent, swelling or breakage of the packaging container is inhibited in Examples 1 to 3, while inhibiting the heat generation that would occur when water is added to the cleaning composition, and that the cleaning compositions of Examples 1 to 3 have high effective chlorine retention.

In Comparative Examples 1 to 3, swelling or breakage of the packaging container and the decrease in effective chlorine retention became more pronounced as the water content of the cleaning composition increased. On the other hand, in Examples 1 to 3, where the water content of the cleaning composition was higher than that in Comparative Example 1, swelling or breakage of the packaging container and the decrease in effective chlorine retention were equivalent or were inhibited. These results demonstrate the effectiveness of Examples 1 to 3.

Similarly, in Comparative Examples 1 to 3, the increase in heat generation temperature is more pronounced as the water content of the cleaning composition decreases, whereas in Examples 2 and 3, where the water content of the cleaning composition is equivalent to or lower than that in Comparative Example 3, the heat generation temperature was equivalent or suppressed as compared with that of Comparative Example 3. In Example 1 as well, the heat generation temperature was significantly suppressed as compared with that in Comparative Example 1, which has the same level of water content as Example 1. These results demonstrate the effectiveness of Examples 1 to 3.

### Examples 4 to 7 and Comparative Examples 4 to 7

Either solid chlorine bleach having a coating layer 1 or sodium dichloroisocyanurate, and sodium metasilicate (anhydrous) and/or sodium metasilicate pentahydrate were blended according to the formulations shown in Table 2 to prepare cleaning compositions having an effective chlorine content of 19.18. These cleaning compositions were packaged in aluminum laminated film. The water content of each cleaning composition, effective chlorine content, pH of each aqueous solution, heat generation temperature, and storage stability test results are as shown in Table 2. The water content was calculated using the same approach as in Examples 1 to 3.

TABLE 2

| | | | | | | | Comp. | Comp. | Comp | Comp |
|---|---|---|---|---|---|---|---|---|---|---|
| | | Formulation | Ex. 4 | Ex. 5 | Ex. 6 | Ex. 7 | Ex. 4 | Ex. 5 | Ex. 6 | Ex. 7 |
| Content | Solid chlorine | Solid chlorine bleach having a | 42.5 | 42.5 | 42.5 | 42.5 | | | | |
| (wt. %) | bleach | coating layer 1 | | | | | | | | |
| | | Sodium dichloroisocyanurate | | | | | 30.3 | 30.3 | 30.3 | 30.3 |
| | Alkaline | Sodium metasilicate | 57.5 | 36.3 | 28.8 | | 69.7 | 58.0 | 34.4 | |
| | compound | (anhydrous) | | | | | | | | |
| | | Sodium metasilicate | | 21.2 | 28.7 | 57.5 | | 11.7 | 35.3 | 69.7 |
| | | pentahydrate | | | | | | | | |
| Water content | Water content derived from solid chlorine bleach | | 1.23 | 1.23 | 1.23 | 1.23 | 0.424 | 0.424 | 0.424 | 0.424 |
| (wt. %) | in the cleaning composition (wt. %) | | | | | | | | | |
| | Water content derived from alkaline compound in | | 0.00 | 9.00 | 12.2 | 24.4 | 0.00 | 4.97 | 15.0 | 29.6 |
| | the cleaning composition (wt. %) | | | | | | | | | |
| | Total water content in the cleaning composition | | 1.23 | 10.23 | 13.4 | 25.6 | 0.42 | 5.39 | 15.4 | 30.0 |
| | (wt. %) | | | | | | | | | |
| | Proportion of alkaline compound-derived water | | 0.0 | 88.0 | 91.0 | 95.3 | 0.0 | 92.2 | 97.4 | 98.7 |
| | content in the water content of the cleaning | | | | | | | | | |
| | composition (wt %) | | | | | | | | | |
| Effective chlorine | Effective chlorine content (%) in the cleaning | | 19.1 | 19.1 | 19.1 | 19.1 | 19.1 | 19.1 | 19.1 | 19.1 |
| content (%) | composition | | | | | | | | | |
| pH | pH of 1 wt. % aqueous solution | | 12.12 | 12.05 | 11.86 | 11.12 | 12.47 | 12.26 | 12.08 | 11.63 |
| Alkaline compound content, excluding hydration water, in the cleaning | | | 57.5 | 48.5 | 45.3 | 33.1 | 69.7 | 64.7 | 54.7 | 40.1 |
| composition (wt. %) | | | | | | | | | | |
| Ratio of effective chlorine content (%) / alkaline compound content | | | 0.33 | 0.39 | 0.42 | 0.58 | 0.27 | 0.29 | 0.35 | 0.48 |
| (excluding hydration water) (wt. %) in the cleaning composition | | | | | | | | | | |
| Total of effective chlorine content (%) and alkaline compound content | | | 76.6 | 67.6 | 64.4 | 52.2 | 88.8 | 83.8 | 73.8 | 59.2 |
| (excluding hydration water) (wt. %) in the cleaning composition | | | | | | | | | | |
| Heat generation | T_{5 ml}(6.8 g / 5 ml) (° C.) | | 39.1 | 33. | 31.5 | 26.8 | 102.2 | 102.2 | 81.3 | 71.7 |
| temperature (° C.) | | | | | | | | | | |

| | | | | | | | | | |
|---|---|---|---|---|---|---|---|---|---|
| Storage stability | Effective chlorine retention (%) (50° C.) | 98.0 | 99.0 | 98.9 | 96.0 | 96.5 | 94.0 | 61.0 *3 | 54.0 *4 |
| test | (4 weeks) | | | | | | | | |
| | Swelling or breakage of packaging container (bag | A | A | A | A | A | C | C | C |
| | breakage) | | | | | | | | |

*3: Bag breakage at 4 weeks; retention (%) after 4 weeks.
*4: Bag breakage at 8 weeks; retention (%) after 8 weeks.

As shown in Table 2, in all of Examples 4 to 7, the heat generation temperature T₅ₘₗ tended to decrease as the water content of the cleaning composition increased. Further, the results showed that in all of the Examples, the effective chlorine retention decreased and swelling of the packaging container was inhibited.

On the other hand, although a tendency for the heat generation temperature to decrease as the water content in the cleaning composition increased was also observed in Comparative Examples 4 to 7, the heat generation temperatures Tom in Comparative Examples 4 to 7 all exceeded 70° C. Furthermore, a high heat generation was observed, with the heat generation temperature Ton exceeding 102° C. in both of Comparative Examples 4 and 5. In addition, in Comparative Examples 4 to 7, the effective chlorine retention decreased as the water content of the cleaning composition increased and a tendency for swelling or breakage of the packaging container to occur was observed. Accordingly, in Examples 4 to 7, the results confirmed that as compared to Comparative Examples 4 to 7, even when the effective chlorine content of cleaning composition is equivalent, swelling or breakage of the packaging container was inhibited while heat generation was inhibited and a high effective chlorine retention was achieved.

In Comparative Examples 4 to 7, swelling or breakage of the packaging container and the decrease in effective chlorine retention became more pronounced as the water content of the cleaning composition increased, whereas in all of Examples 4 to 7, where the water content of the cleaning composition was higher than that in Comparative Example 4, swelling or breakage of the packaging container and the reduction in effective chlorine retention were equivalent or suppressed. This demonstrated the effectiveness of Examples 4 to 7.

Similarly, in Comparative Examples 4 to 7, the increase in heat generation temperature is more pronounced as the water content of the cleaning composition decreases, whereas in all of Examples 4 to 7, where the water content of the cleaning composition is lower than that in Comparative Example 7, the heat generation temperature was inhibited as compared with Comparative Example 7. This demonstrates the effectiveness of Examples 4 to 7.

### Examples 8 to 11 and Comparative Examples 8 to 11

Either solid chlorine bleach having a coating layer 1 or sodium dichloroisocyanurate, and sodium metasilicate (anhydrous) and/or sodium metasilicate pentahydrate were blended according to the formulations shown in Table 3 to prepare cleaning compositions having an effective chlorine content of 22.5%. These cleaning compositions were packaged in aluminium-laminated film. The water content of each cleaning composition, effective chlorine content, pH of each aqueous solution, heat generation temperature, and storage stability test results are as shown in Table 3. The water content was calculated using the same approach as in Examples 1 to 3.

TABLE 3

| | | | | | | | Comp. | Comp. | Comp. | Comp. |
|---|---|---|---|---|---|---|---|---|---|---|
| | | Formulation | Ex. 8 | Ex 9 | Ex. 10 | Ex. 11 | Ex. 8 | Ex. 9 | Ex. 10 | Ex. 11 |
| Content | Solid | Solid chlorine bleach having a | 50.0 | 50.0 | 50.0 | 50.0 | | | | |
| (wt. %) | chlorine | coating layer 1 | | | | | | | | |
| | bleach | Sodium dichloroisocyanurate | | | | | 35.7 | 35.7 | 35.7 | 35.7 |
| | Alkaline | Sodium metasilicate (anhydrous) | 50.0 | 38.0 | 25.0 | | 64.3 | 52.6 | 29.0 | |
| | compound | Sodium metasilicate pentahydrate | | 12.0 | 25.0 | 50.0 | | 11.7 | 35.3 | 64.3 |

| Water | Water content derived from solid chlorine bleach | 1.45 | 1.45 | 1.45 | 1.45 | 0.500 | 0.500 | 0.500 | 0.500 |
|---|---|---|---|---|---|---|---|---|---|
| content | in the cleaning composition (wt. %) | | | | | | | | |
| (wt. %) | Water content derived from alkaline compound | 0.00 | 5.10 | 10.6 | 21.2 | 0.00 | 4.97 | 15.0 | 27.3 |
| | in the cleaning composition (wt. %) | | | | | | | | |
| | Total water content in the cleaning composition | 1.45 | 6.55 | 12.1 | 22.7 | 0.50 | 5.47 | 15.5 | 27.8 |
| | (wt. %) | | | | | | | | |
| | Proportion of alkaline compound-derived water | 0.0 | 77.9 | 87.6 | 93.4 | 0.0 | 90.9 | 96.8 | 98.2 |
| | content in the water content of the cleaning | | | | | | | | |
| | composition (wt. %) | | | | | | | | |
| Effective | Effective chlorine content (%) in the cleaning | 22.5 | 22.5 | 22.5 | 22.5 | 22.5 | 22.5 | 22.5 | 22.5 |
| chlorine | composition | | | | | | | | |
| content (%) | | | | | | | | | |
| pH | pH of 1 wt. % aqueous solution | 12.13 | 12.05 | 11.11 | 10.66 | 12.13 | 12.05 | 11.53 | 10.84 |
| Alkaline compound content, excluding hydration water, in the cleaning | | 50.0 | 44.9 | 39.4 | 28.8 | 64.3 | 59.3 | 49.3 | 37.0 |
| composition(wt %) | | | | | | | | | |
| Ratio of effective chlorine content (%) / alkaline compound content | | 0.45 | 0.50 | 0.57 | 0.78 | 0.35 | 0.38 | 0.46 | 0.61 |
| (excluding hydration water) (wt. %) in the cleaning composition | | | | | | | | | |
| Total of effective chlorine content (%) and alkaline compound content | | 72.5 | 67.4 | 61.9 | 51.3 | 86.8 | 81.8 | 71.8 | 59.5 |
| (excluding hydration water) (wt. %) in the cleaning composition | | | | | | | | | |
| Heat generation | 15 ml (6.8 g / 5 ml) (° C.) | 53.7 | 29.2 | 27.4 | 32.6 | 104.0 | 105.7 | 97.6 | 99.0 |
| temperature (° C.) | | | | | | | | | |
| Storage stability | Effective chlorine retention (%) (50° C.) (4 weeks) | 98.0 | 97.4 | 97.0 | 98.0 | 98.0 | 90.0 | 70.0 *5 | 54.0 *6 |
| test | Swelling or breakage of packaging container (bag | A | A | A | A | A | C | C | C |
| | breakage) | | | | | | | | |

*5: Bag breakage at 21 weeks, retention (%) after 21 weeks
*6: Bag breakage at 7 days; retention (%) after 7 days.

As shown in Table 3, in all of Examples 8 to 11, the heat generation temperature Ton tended to decrease as the water content of the cleaning composition increased. Further, the results show that in all of the Examples, the reduction of effective chlorine retention and swelling of the packaging container were inhibited.

On the other hand, in Comparative Examples 8 to 11 as well, a tendency for the heat generation temperature to decrease as the water content of the cleaning composition increased was observed; however, a high heat generation was observed with the heat generation temperature Tom exceeding 95° C. in Comparative Examples 8 to 11. In addition, in Comparative Examples 9 to 11, the effective chlorine retention decreased as the water content of the cleaning composition increased, and a tendency for swelling or breakage of the packaging container to occur was observed. Accordingly, the results confirmed that as compared to Comparative Examples 8 to 11, even when the effective chlorine content is equivalent, the cleaning compositions of Examples 8 to 11 inhibit swelling or breakage of the packaging container while inhibiting heat generation, and have a high effective chlorine retention.

In Comparative Examples 8 to 11, swelling or breakage of the packaging container and the decrease in effective chlorine retention became more pronounced as the water content of the cleaning composition increased, whereas in all of Examples 8 to 11, where the water content of the cleaning composition was higher than that of Comparative Example 8, the swelling or breakage of the packaging container and the decrease in effective chlorine retention were inhibited to the same extent or more than that in Comparative Example 8. Even in comparison with Comparative Example 9, the swelling or breakage of the packaging container and the decrease in effective chlorine retention were inhibited better in Examples 9 to 11, where the water content of the cleaning compositions was higher than that in Comparative Example 9. This demonstrates the effectiveness of Examples 8 to 11.

Similarly, in Comparative Examples 8 to 11, a rise in heat generation temperature is more pronounced as the water content of the cleaning composition decreases, whereas in all of Examples 8 to 11, where the water content of the cleaning composition was lower than in Comparative Example 11, the heat generation temperature was lower than that in Comparative Example 11. This demonstrates the effectiveness of Examples 8 to 11.

### Example 12 and Comparative Example 12

Either the solid chlorine bleach having a coating layer 1 or sodium dichloroisocyanurate, and sodium metasilicate (anhydrous) and sodium metasilicate nonahydrate were blended according to the formulations shown in Table 4 to prepare cleaning compositions having an effective chlorine content of 19.1% and a water content of 25.6 wt. %. These cleaning compositions were packaged in aluminium-laminated film. The water content of each cleaning composition, effective chlorine content, pH of each aqueous solution, heat generation temperature, and storage stability test results are as shown in Table 4. The water content was calculated using the same approach as in Examples 1 to 3.

TABLE 4

| | | Formulation | Example 12 | Comp. Ex. 12 |
|---|---|---|---|---|
| Content (wt. %) | Solid chlorine bleach | Solid chlorine bleach containing a coating layer 1 | 42.5 | |
| | | Sodium dichloroisocyanurate | | 30.3 |
| | Alkaline compound | Sodium metasilicate (anhydrous) | 14.7 | 25.5 |
| | | Sodium metasilicate pentahydrate | | |
| | | Sodium metasilicate nonahydrate | 42.8 | 44.2 |

| Water content | Water content derived from solid chlorine bleach in the cleaning composition (wt. %) | 1.23 | 0.424 |
|---|---|---|---|
| (wt. %) | Water content derived from alkaline compound in the cleaning composition (wt. %) | 24.4 | 25.2 |
| | Total water content in the cleaning composition (wt. %) | 25.6 | 25.6 |
| | Proportion of alkaline compound-derived water content in the water content of the | 95.3 | 98.4 |
| | cleaning composition (wt. %) | | |
| Effective chlorine | Effective chlorine content (%) in the cleaning composition | 19.1 | 19.1 |
| content (%) | | | |
| pH | pH of 1 wt. % aqueous solution | 11.13 | 11.64 |
| Alkaline compound content, excluding hydration water, in the cleaning composition (wt. %) | | 33.1 | 44.5 |
| Ratio of effective chlorine content (%)/alkaline compound content (excluding hydration water) (wt. %) | | 0.58 | 0.43 |
| in the cleaning composition | | | |
| Total of effective chlorine content (%)/alkaline compound content (excluding hydration water) (wt. %) | | 52.2 | 63.6 |
| in the cleaning composition | | | |
| Heat generation | T_{5 ml} (6.8 g/5 ml) (° C.) | 27.7 | 76.8 |
| temperature (° C.) | | | |
| Storage stability test | Effective chlorine retention (%) (50° C.) (4 weeks) | 98.0 | 70.0 *7 |
| | Swelling or breakage of packaging container (bag breakage) | A | C |

*7: Bag breakage at 7 days; retention (%) after 7 days.

As shown in Table 4, a comparison of Example 12 with Comparative Example 12, which are equivalent in terms of effective chlorine content of the cleaning composition and water content of the cleaning composition, shows that in Example 12, the heat generation temperature Tom was suppressed, a high effective chlorine retention was maintained, and no swelling of the packaging container occurred, whereas in Comparative Example 12, a high heat generation temperature Tom was observed, the effective chlorine retention was significantly reduced, and swelling and breakage of the packaging container occurred. This demonstrated the effectiveness of Example 12.

### Examples 13 to 15 and Comparative Examples 13 to 15

Either the solid chlorine bleach having a coating layer 1 or sodium dichloroisocyanurate, and sodium metasilicate (anhydrous), sodium metasilicate pentahydrate, sodium metasilicate nonahydrate, and diphosphate sodium decahydrate, as well as tetrasodium ethylenediamine tetraacetate dihydrate and trisodium citrate dihydrate as other additives were blended according to the formulations shown in Table 5 to prepare cleaning compositions having an effective choline content of 19.1%. These cleaning compositions were packaged in aluminum-laminated film. The water content of each cleaning composition, effective chlorine content, pH of each aqueous solution, heat generation temperature, and storage stability test results are as shown in Table 5. The water content was calculated using the same approach as in Examples 1 to 3. The water content of tetrasodium ethylenediaminetetraacetate dihydrate was 8.66 wt. % and that of trisodium citrate dihydrate was 12.3 wt. %.

TABLE 5

| | | | Example | Example | Example | Comp. | Comp. | Comp. |
|---|---|---|---|---|---|---|---|---|
| | | Formulation | 13 | 14 | 15 | Ex. 13 | Ex. 14 | Ex. 15 |
| Content | Solid chlorine | Solid chlorine bleach containing a coating | 42.50 | 42.50 | 42.50 | | | |
| (wt. %) | | layer 1 | | | | | | |
| | bleach | Sodium dichloroisocyanurate | | | | 30.30 | 30.30 | 30.30 |
| | Alkaline | Sodium metasilicate (anhydrous) | 21.25 | 21.25 | 21.25 | 28.17 | 28.17 | 28.17 |
| | compound | Sodium metasilicate pentahydrate | 16.25 | 16.25 | | 21.53 | 21.53 | |
| | | Sodium metasilicate nonahydrate | | | | | | |
| | | Sodium diphosphate decahydrate | | | 16.25 | | | 21.53 |
| | Component C | Tetrasodium ethylenediaminetetraacetate | 20.00 | | | 20.00 | | |
| | | dihydrate | | | | | | |
| | Other additive | Trisodium citrate dihydrate | | 20.00 | 20.00 | | 20.00 | 20.00 |
| Water content | Water content derived from solid chlorine bleach in the cleaning | | 1.23 | 1.23 | 1.23 | 0.424 | 0.424 | 0.424 |
| (wt. %) | composition (wt. %) | | | | | | | |
| | Water content derived from alkaline compound in the cleaning | | 6.90 | 6.90 | 6.56 | 9.14 | 9.14 | 8.70 |
| | composition (wt. %) | | | | | | | |
| | Other additive-derived water content (wt. %) in the cleaning | | 1.73 | 2.45 | 2.45 | 1.73 | 2.45 | 2.45 |
| | composition | | | | | | | |
| | Total water content in the cleaning composition (wt. %) | | 9.86 | 10.58 | 10.24 | 11.29 | 12.01 | 11.57 |
| | Proportion of alkaline compound-derived water content in the | | 70.0 | 65.2 | 64.1 | 81.0 | 76.1 | 75.2 |
| | water content of the cleaning composition(wt. %) | | | | | | | |
| Effective chlorine | Effective chlorine content (%) in the cleaning composition | | 19.1 | 19.1 | 19.1 | 19.1 | 19.1 | 19.1 |
| content (%) | | | | | | | | |
| pH | pH of 1 wt % aqueous solution | | 10.52 | 10.68 | 10.10 | 11.29 | 11.38 | 10.42 |
| Alkaline compound content, excluding hydration water, in the cleaning | | | 30.6 | 30.6 | 30.9 | 40.6 | 40.6 | 41.0 |
| composition(wt. %) | | | | | | | | |
| Ratio of effective chlorine content (%) / alkaline compound content (excluding | | | 0.62 | 0.62 | 0.62 | 0.47 | 0.47 | 0.47 |
| hydration water) (wt. %) in the cleaning composition | | | | | | | | |
| Total of effective chlorine content (%) and alkaline compound content (excluding | | | 49.7 | 49.7 | 50.0 | 59.7 | 59.7 | 60.1 |
| hydration water) (wt. %) in the cleaning composition | | | | | | | | |
| Heat generation | T_{5 ml} (6.8 g / 5 ml) (° C.) | | 39.1 | 26.7 | 33.9 | 103.8 | 94.0 | 100.0 |
| temperature (° C.) | | | | | | | | |

| | | | | | | | |
|---|---|---|---|---|---|---|---|
| Storage stability | Effective chlorine retention (%) (50° C.) (4 weeks) | 96.7 | 98.5 | 95.5 | 96.0 | 96.8 | 71.7 |
| test | Swelling or breakage of packaging container (bag breakage) | A | A | A | A | A | C |

As shown in Table 5, in Examples 13 to 15, the heat generation temperature Tom was inhibited, high effective chlorine retention was maintained, and no swelling of the packaging container occurred, whereas in Comparative Examples 13 to 15, high heat generation temperature Tem was observed, and in Comparative Example 15, the effective chlorine retention significantly decreased and swelling or breakage of the packaging container occurred.

### Examples 16 to 18

One of solid chlorine bleaches having a coating layer 2 to 4, sodium metasilicate (anhydrous), and sodium metasilicate pentahydrate were blended according to the formulations shown in Table 6 to prepare cleaning compositions having an alkaline compound content, excluding hydration water, of 48.5%. These cleaning compositions were packaged in aluminum-laminated film. The water content of each cleaning composition, effective chlorine content, pH of each aqueous solution, heat generation temperature, and storage stability test results are as shown in Table 6. The water content was calculated using the same approach as in Examples 1 to 3.

TABLE 6

| | | | Example | Example | Example |
|---|---|---|---|---|---|
| | | Formulation | 16 | 17 | 18 |
| Content (wt. %) | Component A | Solid chlorine bleach having a | | | |
| | | coating layer 1 | | | |
| | | Solid chlorine bleach having a | 42.50 | | |
| | | coating layer 2 | | | |
| | | Solid chlorine bleach having a | | 42.50 | |
| | | coating layer 3 | | | |
| | | Solid chlorine bleach having a | | | 42.50 |
| | | coating layer 4 | | | |
| | | Sodium dichloroisocyanurate | | | |
| | Component B | Sodium metasilicate (anhydrous) | 36.25 | 36.25 | 36.25 |
| | Alkaline | Sodium metasilicate pentahydrate | 21.25 | 21.25 | 21.25 |
| | compound | Sodium metasilicate nonahydrate | | | |

| Water content | Water content derived from solid chlorine bleach in | 2.38 | 1.27 | 0.795 |
|---|---|---|---|---|
| (wt. %) | the cleaning composition (wt. %) | | | |
| | Water content derived from alkaline compound in | 9.02 | 9.02 | 9.02 |
| | the cleaning composition (wt. %) | | | |
| | Total water content in the cleaning composition | 11.40 | 10.29 | 9.82 |
| | (wt. %) | | | |
| | Proportion of alkaline compound-derived water | 79.1 | 87.7 | 91.9 |
| | content in the water content of the cleaning | | | |
| | composition (wt. %) | | | |
| Effective chlorine | Effective chlorine content (%) in the cleaning | 20.0 | 19.0 | 19.9 |
| content(%) | composition | | | |
| pH | pH of 1 wt. % aqueous solution | 12.24 | 12.11 | 12.17 |
| Alkaline compound content, excluding hydration water, in the | | 48.5 | 48.5 | 48.5 |
| cleaning composition (wt. %) | | | | |
| Ratio of effective chlorine content (%)/alkaline compound content | | 0.41 | 0.39 | 0.41 |
| (excluding hydration water) (wt. %) in the cleaning composition | | | | |
| Total of effective chlorine content (%) and alkaline compound | | 68.5 | 67.5 | 68.4 |
| content (excluding hydration water) (wt. %) in the cleaning | | | | |
| composition | | | | |
| Heat generation | T_{5 ml} (6.8 g/5 ml) (° C.) | 30.8 | 40.2 | 32.4 |
| temperature (° C.) | | | | |
| Storage stability | Effective chlorine retention (%) (50° C.) (4 weeks) | 96.1 | 99.6 | 98.9 |
| test | Swelling or breakage of packaging container (bag | A | A | A |
| | breakage) | | | |

As shown in Table 6, all of the cleaning compositions in Examples 16 to 18 inhibited the heat generation temperature T₅ₘₗ and maintained a high effective chlorine retention, and no swelling of the packaging container occurred.

### Comparative Example 16

The solid chlorine bleach having a coating layer 1, sodium metasilicate nonahydrate, and distilled water were blended according to the formulations shown in Table 7 to prepare coating compositions having an effective chlorine content of 19.1%. These cleaning compositions were packaged in aluminum-laminated film. The water content of each cleaning composition, effective chlorine content, pH of each aqueous solution, heat generation temperature, and storage stability test results are as shown in Table 7. Table 7 also shows the results of Example 12. The water content was calculated using the same approach as in Examples 1 to 3.

TABLE 7

| | | | | Comp. |
|---|---|---|---|---|
| | | Formulation | Example 12 | Ex. 16 |
| Content (wt. %) | Solid | Solid chlorine bleach having a | 42.5 | 42.5 |
| | chlorine | coating layer 1 | | |
| | bleach | Sodium dichloroisocyanurate | | |
| | Alkaline | Sodium metasilicate (anhydrous) | 14.7 | |
| | compound | Sodium metasilicate pentahydrate | | |
| | | Sodium metasilicate nonahydrate | 42.8 | 42.8 |

| | Distilled water | | 14.7 |
|---|---|---|---|
| Water content | Water content derived from solid chlorine bleach in | 1.23 | 1.23 |
| (wt. %) | the cleaning composition (wt. %) | | |
| | Water content derived from alkaline compound in the | 24.4 | 24.4 |
| | cleaning composition (wt. %) | | |
| | Distilled water content (wt. %) in the cleaning | 0.00 | 14.7 |
| | composition | | |
| | Total water content in the cleaning composition (wt. %) | 25.6 | 40.3 |
| | Proportion of alkaline compound-derived water | 95.3 | 60.5 |
| | content in the water content of the cleaning | | |
| | composition (wt. %) | | |
| Effective chlorine | Effective chlorine content (%) in the cleaning | 19.1 | 19.1 |
| content(%) | composition | | |
| pH | pH of 1 wt. % aqueous solution | 11.13 | 11.72 |
| Alkaline compound content, excluding hydration water, in the cleaning | | 33.1 | 18.4 |
| composition (wt. %) | | | |
| Ratio of effective chlorine content (%)/alkaline compound content | | 0.58 | 1.04 |
| (excluding hydration water) (wt. %) in the cleaning composition | | | |
| Total of effective chlorine content (%) and alkaline compound content | | 52.2 | 37.5 |
| (excluding hydration water) (wt. %) in the cleaning composition | | | |
| Heat generation | T_{5 ml} (6.8 g/5 ml) (° C.) | 27.7 | 29.1 |
| temperature (° C.) | | | |
| Storage stability | Effective chlorine retention (%) (50° C.) (4 weeks) | 98.0 | 48.0 *8 |
| test | Swelling or breakage of packaging container (bag | A | C |
| | breakage) | | |

*8: Bag breakage at 6 hours; retention rate after 6 hours.

As shown in Table 7, a comparison of Example 12 with Comparative Example 16 shows that since the water content of the cleaning composition was as high as 40.3 wt.& in Comparative Example 16, the effective chlorine retention was significantly reduced and swelling or breakage of the packaging container occurred.

### Comparative Example 17

Solid chlorine bleach having a coating layer 1, sodium metasilicate (anhydrous), and sodium metasilicate pentahydrate, as well as tetrasodium ethylenediaminetetraacetate dihydrate as another additive, were blended according to the formulation shown in Table 8 to prepare a cleaning composition having an effective chlorine content of 2.8%. This cleaning composition was packaged in aluminium-laminated film. The water content of each cleaning composition, effective chlorine content, pH of each aqueous solution, heat generation temperature, storage stability test results, and cleaning test results are as shown in Table 8. Table 8 also includes the results of Examples 1, 5, and 13. The water content was calculated using the same approach as in Examples 1 to 3.

TABLE 8

| | | | | | | Comp. Ex. |
|---|---|---|---|---|---|---|
| | | Formulation | Example 1 | Example 5 | Example 13 | 17 |
| Content | Solid chlorine | Solid chlorine bleach having a coating layer 1 | 30.0 | 42.5 | 42.50 | 6.2 |
| (wt. %) | bleach | Sodium dichloroisocyanurate | | | | |
| | Alkaline | Sodium metasilicate (anhydrous) | 70.0 | 36.3 | 21.25 | 52.6 |
| | compound | Sodium metasilicate pentahydrate | | 21.2 | 16.25 | 21.2 |
| | | Sodium metasilicate nonahydrate | | | | |
| | | Sodium diphosphate decahydrate | | | | |
| | Other additive | Tetrasodium ethylenediaminetetraacetate dihydrate | | | 20.00 | 20.0 |
| | | Trisodium citrate dihydrate | | | | |
| Water content | Water content derived from solid chlorine bleach in the cleaning composition | | 0.870 | 1.23 | 1.23 | 0.180 |
| (wt. %) | (wt. %) | | | | | |
| | Water content derived from alkaline compound in the cleaning composition | | 0.00 | 9.00 | 6.90 | 9.00 |
| | (wt. %) | | | | | |
| | Other additive-derived water content (wt. %) in the cleaning composition | | 0.00 | 0.00 | 1.73 | 1.73 |
| | Total water content in the cleaning composition (wt. %) | | 0.87 | 10.23 | 9.86 | 10.91 |
| | Proportion of alkaline compound-derived water content in the water content of | | 0.0 | 88.0 | 70.0 | 82.5 |
| | the cleaning composition (wt. %) | | | | | |
| Effective chlorine | Effective chlorine content (%) in the cleaning composition | | 13.5 | 19.1 | 19.1 | 2.8 |
| content (%) | | | | | | |
| pH | pH of 1 wt % aqueous solution | | 12.40 | 12.05 | 10.52 | 12.41 |
| Alkaline compound content, excluding hydration water, in the cleaning composition (wt. %) | | | 70.0 | 48.5 | 30.6 | 64.8 |
| Ratio of effective chlorine content (%) / alkaline compound content (excluding hydration water) | | | 0.19 | 0.39 | 0.62 | 0.043 |
| (wt. %) in the cleaning composition | | | | | | |
| Total of effective chlorine content (%) and alkaline compound content (excluding hydration water) | | | 83.5 | 67.6 | 49.7 | 67.6 |
| (wt. %) in the cleaning composition | | | | | | |
| Heat generation | T_{5 ml} (6.8 g / 5 ml) (° C.) | | 35.5 | 33.1 | 39.1 | 28.7 |
| temperature (° C.) | | | | | | |
| Storage stability | Effective chlorine retention (%) (50° C.) (4 weeks) | | 99.0 | 99.0 | 96.7 | 95.7 |
| Test | Swelling or breakage of packaging container (bag breakage) | | A | A | A | A |
| Cleaning Test 1 | Concentration of the cleaning composition (wt. %) | | 0.02 | 0.02 | 0.02 | 0.02 |
| | Effective chlorine concentration in the cleaning composition (mg/L) | | 26.7 | 39.3 | 38.3 | 4.7 |
| | pH of the aqueous cleaning solution (cleaning composition concentration: 0.02 | | 10.60 | 10.07 | 9.81 | 10.74 |
| | wt %) | | | | | |
| | Whiteness | Whiteness of the area not immersed in the coating | 27.9 | 27.7 | 28.5 | 28.4 |
| | | solution | | | | |
| | | Whiteness of area immersed in the cleaning solution | 42.3 | 50.6 | 52.1 | 33.0 |
| | | Difference in whiteness | 14.4 | 22.9 | 23.6 | 4.6 |

| | | | | | |
|---|---|---|---|---|---|
| Cleaning Test 2 | Test piece cleaning results | B | A | A | C |

As shown in the results of Table 8, the results of cleaning tests 1 and 2 show that as compared with the cleaning compositions of Examples 1, 5, and 13, the cleaning composition of Comparative Example 17 exhibited a low cleaning effect, which was due to the cleaning composition of Comparative Example 17 having an effective chlorine content as low as 2.8%.

### Example 19

Aluminium-laminated film containing 200 g of the cleaning composition of Example 5 as a cleaning agent was opened. The entire 200 g of the cleaning composition was placed into the washing drum of a drum-type washing machine (Panasonic, NA-VG740L). The washing drum was cleaned by selecting the “leave it to us” course on the washing machine panel. After cleaning, the aqueous solution that flowed out of the drainpipe of the washing machine was collected and the effective chlorine concentration and pH were measured. Water was poured into the washing drum and it was confirmed through the door window of the washing machine that cleaning composition dissolved in the drum without any abnormalities.

As a result, the “leave it to us” course was selected, and about 20 minutes after the “leave it to us” course was started, the first drainage was performed. Wastewater was collected as a sample from the washing machine drainpipe during the draining operation, and the effective chlorine concentration and pH were measured. The effective chlorine concentration was 3875 mg/L and the pH was 12.49. Thus, the sample had a sufficient effective chlorine concentration and alkalinity. The results suggest that the cleaning composition can be expected to provide a high cleaning effect on the lint filter in the washing drum and the drainage channel, as well as the inside of the drainage pipe. Further, in the first drainage, wastewater was collected from the drainpipe. The amount of wastewater collected was 9L. Thus, the concentration of the cleaning agent was considered to be 23 g/L.

### Example 20

Aluminium-laminated film containing 200 g of the cleaning composition of Example 5 as a cleaning agent was opened, and the entire 200 g of the cleaning composition was placed into the washing drum of a drum-type washing machine (Panasonic, NA-VG740L). The washing drum was cleaned by selecting the “drum cleaning course” (water temperature: about 30° C.) on the washing machine panel. Five minutes after the start of drum cleaning, cleaning was temporally halted and the aqueous cleaning solution in the drum was sampled to measure the effective chlorine concentration and pH. After drum cleaning was started, it was confirmed through a door window of the washing machine that the cleaning composition dissolved in the drum without any abnormalities. The drum cleaning course continued for about 150 minutes.

As a result, 5 minutes after the start of drum cleaning, the aqueous solution in the washing drum had an effective chlorine concentration of 1939 mg/L and a pH of 11.83, thus having a sufficient effective chlorine concentration and high alkalinity. The results suggest that the cleaning composition can be expected to provide a high cleaning effect on lint filters in the washing drum and the drainage channel, as well as the inside of the drainage pipe. The difference in effective chlorine concentration and pH of the aqueous cleaning solution in the washing drum between Example 19 and the aqueous cleaning solution in the washing machine drum was considered attributable to the difference in water volume etc. in the course selected for the washing machine.

The above results show that as compared to the cleaning compositions of the Comparative Examples, the cleaning compositions of the present invention have extremely high bleaching and cleaning effects on the target object and also have excellent storage stability while inhibiting heat generation that could occur upon addition of a small amount of water.

### Comparative Examples 18 to 20

Sodium dichloroisocyanurate, sodium metasilicate (anhydrous), and sodium metasilicate pentahydrate, as well as tetrasodium ethylenediaminetetraacetate dihydrate and trisodium citrate dihydrate as other additives, were blended according to the formulation shown in Table 9 to prepare cleaning compositions having an effective chlorine content in the range of 3.9 to 10%. These cleaning compositions were packaged in aluminium-laminated film. The water content of each cleaning composition, effective chlorine content, pH of each aqueous solution, and heat generation temperature were as shown in Table 9. The water content was calculated using the same approach as in the Examples and Comparative Examples above.

TABLE 9

| | | | Comp. | Comp. | Comp. |
|---|---|---|---|---|---|
| | | Formulation | Ex. 18 | Ex. 19 | Ex. 20 |
| Content (wt. %) | Solid | Solid chlorine bleach having a coating layer 1 | | | |
| | chlorine | Sodium dichloroisocyanurate | 6.2 | 9.6 | 15.9 |
| | bleach | | | | |
| | Alkaline | Sodium metasilicate (anhydrous) | 52.6 | 52.6 | 52.6 |
| | compound | Sodium metasilicate pentahydrate | 21.2 | 21.2 | 21.2 |
| | | Sodium metasilicate nonahydrate | | | |
| | | Sodium diphosphate decahydrate | | | |
| | Other | Tetrasodium ethylenediaminetetraacetate | 20.0 | 16.6 | 10.3 |
| | additives | dihydrate | | | |
| | | Trisodium citrate dihydrate | | | |

| Water content | Water content derived from solid chlorine bleach in the | 0.087 | 0.134 | 0.223 |
|---|---|---|---|---|
| (wt. %) | cleaning composition (wt. %) | | | |
| | Water content derived from alkaline compound in the cleaning | 9.00 | 9.00 | 9.00 |
| | composition (wt. %) | | | |
| | Other additive-derived water content (wt. %) in the cleaning | 1.73 | 1.44 | 0.892 |
| | composition | | | |
| | Total water content in the cleaning composition (wt. %) | 10.82 | 10.57 | 10.12 |
| | Proportion of alkaline compound-derived water content in the | 83.2 | 85.1 | 89.0 |
| | water content of the cleaning composition (wt. %) | | | |
| Effective chlorine | Effective chlorine content (%) in the cleaning composition | 3.9 | 6.0 | 10.0 |
| content (%) | | | | |
| pH | pH of 1 wt % aqueous solution | 12.53 | 12.54 | 12.49 |
| Alkaline compound content, excluding hydration water, in the cleaning composition | | 64.8 | 64.8 | 64.8 |
| (wt. %) | | | | |
| Ratio of effective chlorine content (%)/alkaline compound content (excluding hydration | | 0.060 | 0.093 | 0.154 |
| water) (wt. %) in the cleaning composition | | | | |
| Total of effective chlorine content (%) and alkaline compound content (excluding | | 68.7 | 70.8 | 74.8 |
| hydration water) (wt. %) in the cleaning composition | | | | |
| Heat generation | T_{5 ml} (6.8 g/5 ml) (° C.) | 39.7 | 46.3 | 80.9 |
| temperature (° C.) | | | | |

As shown in Table 9, a comparison of Comparative Examples 18 to 20 shows that the higher the effective chlorine content of the cleaning composition, the higher the heat generation temperature Tim. In particular, in Comparative Example 20, where the effective chlorine content of the cleaning composition was 10%, the heat generation temperature Tom was higher than 80° C. This result confirmed that the higher the effective chlorine content of the cleaning composition, the more intensely heat generation occurs when water is added. Accordingly, it was confirmed that when applied as a cleaning composition with a high effective chlorine content, the cleaning composition of the present invention provides a remarkable heat generation-inhibiting effect and is of great significance.

The present invention can provide a cleaning composition that inhibits heat generation that would occur when the cleaning composition is dissolved in water, that inhibits swelling and breakage of a packaging container containing the cleaning composition, and that allows a bleaching agent to be stably maintained in the cleaning composition and exhibits an excellent bleaching effect. The present invention can further provide a cleaning method using the cleaning composition. The cleaning composition of the present invention can simultaneously achieve the following effects while exhibiting high bleaching and cleaning effects: the effect of inhibiting heat generation when water is added to the cleaning composition; the effect of inhibiting swelling or breakage of the packaging container containing the cleaning composition; and the effect of maintaining a high effective chlorine retention in chlorine bleach. These are remarkable effects that cannot be expected from the prior art.

### INDUSTRIAL APPLICABILITY

The present invention is industrially applicable because it can provide a cleaning composition that has high bleaching and cleaning effects, that inhibits heat generation when water is added to the cleaning composition, that inhibits the swelling or breakage of the packaging container, and that further has excellent storage stability.

1. A solid cleaning composition comprising a material containing solid chlorine bleach having a coating layer and an alkaline compound,
wherein the cleaning composition has an effective chlorine content of 5% or more and a water content of 40 wt. % or less, and a 1 wt. % aqueous solution of the cleaning composition has a pH of 9 or higher.

2. The cleaning composition according to claim 1, wherein a content of the alkaline compound in the cleaning composition is 5 wt. % or more, with a proviso that bound water is excluded when the alkaline compound contains bound water.

3. The cleaning composition according to claim 1, wherein a sum of the effective chlorine content and a content of the alkaline compound in the cleaning composition is 40 or more, with a proviso that bound water is excluded from the content of the alkaline compound when the alkaline compound contains bound water.

4. The cleaning composition according to claim 1 or 2, wherein a ratio of the effective chlorine content to the alkaline compound content, which is the effective chlorine content/the alkaline compound content, in the cleaning composition is in a range of 0.1 to 0.8.

5. The cleaning composition according to claim 1, wherein the alkaline compound is at least one member selected from the group consisting of metal metasilicates, metal metasilicate hydrates, metal phosphates, metal phosphate hydrates, and mixtures thereof.

6. The cleaning composition according to claim 1, wherein water derived from the alkaline compound accounts for 60 wt. % or more of the water content of the cleaning composition.

7. The cleaning composition according to claim 1, wherein the water content of the cleaning composition is 32 wt. % or less.

8. The cleaning composition according to claim 1, wherein a 1 wt. % aqueous solution of the cleaning composition has a pH of 10.5 or higher.

9. A method for cleaning an object, comprising bringing an aqueous solution of the cleaning composition of claim 1 into contact with the object.

10. The cleaning composition according to claim 2, wherein a sum of the effective chlorine content and a content of the alkaline compound in the cleaning composition is 40 or more, with the proviso that bound water is excluded from the content of the alkaline compound when the alkaline compound contains bound water.

11. The cleaning composition according to claim 2, wherein a ratio of the effective chlorine content to the alkaline compound content, which is the effective chlorine content/the alkaline compound content, in the cleaning composition is in a range of 0.1 to 0.8.

12. The cleaning composition according to claim 2, wherein the alkaline compound is at least one member selected from the group consisting of metal metasilicates, metal metasilicate hydrates, metal phosphates, metal phosphate hydrates, and mixtures thereof.

13. The cleaning composition according to claim 2, wherein water derived from the alkaline compound accounts for 60 wt. % or more of the water content of the cleaning composition.

14. The cleaning composition according to claim 2, wherein the water content of the cleaning composition is 32 wt. % or less.

15. The cleaning composition according to claim 2, wherein a 1 wt. % aqueous solution of the cleaning composition has a pH of 10.5 or higher.

16. A method for cleaning an object, comprising bringing an aqueous solution of the cleaning composition of claim 2 into contact with the object.
